(19) United States
(12) Patent Application Publication
(10) Pub. No.: US 2017/0335071 A1
(43) Pub. Date: Nov. 23, 2017

(54) COMPOSITION CONTAINING BIS-UREAS FOR FORMING STABLE GELS

(71) Applicants: UNIVERSITE PIERRE ET MARIE CURRIE - PARIS 6 (UPMC), Paris (FR); CENTRE NATIONAL DE LA RECHERCHE SCIENTIFIQUE (CNRS), Paris (FR)

(72) Inventors: Laurent BOUTEILLER, Bourg la Reine (FR); Emilie RESSOUCHE, Paris (FR); Sandrine PENSEC, Vauhallan (FR); Benjamin ISARE, Paris (FR)

(21) Appl. No.: 15/517,826

(22) PCT Filed: Oct. 9, 2015
(86) PCT No.: PCT/FR2015/052731

§ 371 Date: Apr. 7, 2017

(30) Foreign Application Priority Data
Oct. 10, 2014 (FR) 1459770

(51) Int. Cl. C08J 3/09; C08J 3/11

(52) U.S. Cl. CPC C08J 3/096; C08J 3/095; C08J 3/11; C08J 3/092; C08J 2333/08; C08J 2371/02; C08J 2383/04; C08J 2323/36

(57) ABSTRACT

The invention relates to a composition comprising classic bis-ureas and bis-ureas functionalised by macromolecular chains, said bis-ureas including complementary spacers of the aryl type, the mixture of said bis-ureas in a solvent leading to a stable physical gel. The invention also relates to a method for producing said composition and to the use of said composition as an organogelator, alone or in a cosmetic preparation, an ink, a fuel or a lubricant, especially of a motor vehicle.

### FIELD OF THE INVENTION

The present invention lies in the field of formulation and proposes novel viscosing solutions. More particularly, the present invention relates to a composition comprising conventional bis-ureas and bis-ureas functionalised by macromolecular chains, these bis-ureas including complementary spacers of the aryl type, mixing said bis-ureas in a solvent leading to a stable physical gel. The present invention also relates to a method for preparing this composition and the use of this composition as an organogelator, alone or in a cosmetic preparation, an ink, a fuel or a lubricant, in particular for automobiles.

### BACKGROUND OF INVENTION

Since the 1980s, the interest raised by organogelators has continually increased, as testified to by the exponential number of publications on the subject.

These small molecules have the ability to structure all kinds of organic solvent, even at relatively low concentrations by mass (less than 1% by mass) and to give them the required texture or viscosity, which in particular attracts the attention of scientists and manufacturers because of the many applications possible.

This particular property is the consequence of intermolecular interactions that are sufficiently stabilising to compensate for the loss of entropy related to the reduction in their degree of freedom when these molecules are placed in contact with solvents. These interactions may be of varied natures: dipolar interactions, Van der Waals forces, π interactions or intra- or intermolecular hydrogen bonds.

The great majority of organogelators provide thermoreversible gels and uses, as the driving force for their autoassembly in solution, intermolecular interactions of the hydrogen bond type.

Among this group, the family of ureas, and particularly bis-ureas, has been widely studied.

The Applicant has developed great expertise in the field of supramolecular chemistry, and in particular in the use of non-covalent interactions of the hydrogen bond type for controlling the assembly of complex architectures and obtaining materials with reversible properties, in particular using symmetrical bis-ureas with the overall structure:

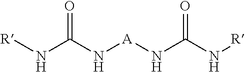

wherein A represents a spacer between the urea functions (preferably an aryl group that may be substituted by alkyl groups, more preferably toluene, xylene or trimethylbenzene) and R′ represents an alkyl group of the aliphatic type, preferably ethylhexyl; the hydrogen bonds are established between the protons of the urea functions of the first molecule and the oxygen atoms of the urea functions of a second molecule.

Depending on the nature of the solvent used, the bis-urea concentration and the temperature, these bis-ureas are autoassociated by hydrogen bonds in filamentary (a) or tubular (b) assemblies:

Filamentary assemblies lead to a liquid solution.
Tubular assemblies lead to a viscoelastic gel.

Obtaining viscoelastic gels is an aim frequently pursued by persons skilled in the art. One of the difficulties encountered then by persons skilled in the art is to arrive at a good solubilisation of the bis-ureas in the required medium. Conventional bis-ureas are not soluble in some solvents, such as those comprising long alkyl chains (C₁₂-C₄₀), which greatly limits the industrial applications, in particular in the field of lubricants. To overcome this problem of solubility of conventional bis-ureas in this type of solvent, i.e. in solvents wherein these bis-ureas are not soluble, one of the paths followed in the prior art is to functionalise the bis-ureas by macromolecular chains.

Thus Pensec et al. (Macromolecules 2010) reported on the synthesis of a bis-urea functionalised by poly(isobutene) chains having a toluene spacer (PIBUT):

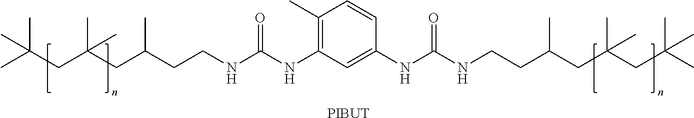

These functionalised bis-ureas are capable of being autoassembled by hydrogen bonds in various types of solvent. However, the steric hindrance of these bis-ureas due to the functionalisation of the poly(isobutene) chains routinely leads to a filamentary autoassembly whatever the nature of the solvent; the composition remains liquid.

An equimolar mixture of conventional bis-ureas of ethylhexylureidotoluene (EHUT)

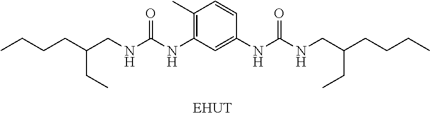 [SMILES: CCCCC(CC)CNC(=O)Nc1ccc(C)c(NC(=O)NCC(CC)CCCC)c1 ; "EHUT"]

and bis-ureas functionalised by PIBUT macromolecular chains, has been studied in heptane, a solvent wherein EHUT bis-ureas and PIBUT bis-ureas are each soluble. The results of this study showed that it is possible to associate in heptane EHUT conventional bis-ureas with bis-ureas functionalised by PIBUT macromolecular chains in order to form gels, but the gels obtained have transition temperatures below that of conventional bis-urea.

Isare et al. (“Engineering the cavity of self-assembled dynamic nanotubes, J. Phys. Chem. B, Vol. 113, 2009, pp 3360-3364) showed that the spacers of bis-ureas may influence the gel-liquid transition temperature; in particular when the mixture comprises bis-ureas having complementary spacers, that is to say bis-ureas having a hindered spacer and bis-ureas having an unhindered spacer. Mixing the conventional ethylhexylureidotoluene (EHUT) bis-urea having a toluene spacer with the conventional ethylhexylureidotrimethylbenzene (EHUTMB) bis-urea having a trimethylbenzene spacer, solubilised in toluene, a solvent wherein EHUT bis-ureas and EHUTMB bis-ureas are each soluble, makes it possible to obtain a gel that has a transition temperature situated around 65° C. whereas EHUT alone with the toluene spacer makes it possible to form a gel that has a transition temperature situated around 40° C., and EHUTMB alone with the TMB spacer makes it possible to form a gel that has a transition temperature of around −5° C.

All these experiments were carried out on conventional bis-ureas and in solvents wherein these bis-ureas are soluble.

To the knowledge of the Applicant, no information is given in the prior art on the behaviour that might be possessed by bis-ureas functionalised by macromolecular chains having a chosen spacer, in a mixture with conventional bis-ureas having a spacer complementary to the chosen spacer.

Moreover, there exists a need to develop novel systems based on ureas making it possible to obtain chemically stable gels in all kinds of solvent, including in solvents wherein conventional bis-ureas are not soluble or do not form a gel; more particularly, in solvents useful in industry, for example solvents containing long alkyl chains or in polar solvents.

Finally, there also exists a need to have systems that make it possible to make gels with a transition temperature suited to the required use.

Surprisingly, the Applicant showed that mixing conventional bis-ureas and bis-ureas functionalised by macromolecular chains, having complementary spacers, was not only possible, but that it led to thermally stable gels, and that it made it possible to improve the solubilisation of conventional bis-ureas and to promote the formation of gels having transition temperatures of interest.

### SUMMARY

The invention therefore relates to a composition comprising a mixture of conventional bis-ureas and bis-ureas functionalised by macromolecular chains, wherein:

the conventional bis-ureas are of general formula (I)

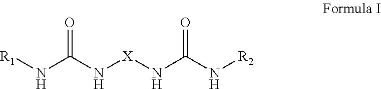

wherein

X represents a group selected from aryl or heteroaryl groups; optionally substituted by one or more groups selected from halogens, alkyls, alkenes, alkynes, heteroalkyls, heteroalkenes or heteroalkynes; preferably, X represents a phenyl group substituted by at least one alkyl chain comprising 1 to 4 carbon atoms and/or at least one halogen selected from Cl or Br;

R₁ and R₂ each represent independently a linear or branched group, selected from alkyl, alkene, alkyne, aryl, arylalkyl, heteroaryl, heteroalkyl, heteroalkene or heteroalkyne; said linear or branched group optionally being substituted by a halogen, alkyl, alkene, alkyne, heteroalkyl, heteroalkene or heteroalkyne group;

the bis-ureas functionalised by macromolecular chains are of general formula (II)

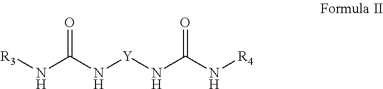

wherein

Y represents a group selected from aryl or heteroaryl groups; optionally substituted by one or more groups selected from halogens, alkyls, alkenes, alkynes, heteroalkyls, heteroalkenes or heteroalkynes; preferably, Y represents a phenyl group substituted by at least one alkyl chain comprising 1 to 4 carbon atoms or at least one halogen selected from Cl or Br;

at least one of R₃ and R₄ represents a macromolecular chain, preferably selected from the family comprising polyacrylates, polymethacrylates, polyolefins, polycarbonates, polyethers, polydienes, polyvinyl acetates, polycarbonates, polysiloxanes, polyesters, polynorbornenes, polycyclooctenes and polystyrenes; and the other one of R₃ and R₄ represents a linear or branched group, selected from alkyl, alkene, alkyne, aryl, arylalkyl, heteroaryl, heteroalkyl, heteroalkene or heteroalkyne; said linear or branched group optionally being substituted by a halogen, alkyl, alkene, alkyne, heteroalkyl, heteroalkene or heteroalkyne group, or a macromolecular chain, preferably selected from the family comprising polyacrylates, polymethacrylates, polyolefins, polycarbonates, polyethers, polydienes, polyvinyl acetates, polycarbonates, polysiloxanes, polyesters, polynorbornenes, polycyclooctenes and polystyrenes; preferably R₃ and R₄ are identical; more preferably R₃ and R₄ are identical and each represent a macromolecular chain of polyisobutene or poly(butyl acrylate);

and

X and Y are complementary spacers.

According to one embodiment, the conventional bis-ureas of formula (I) are selected from ethylhexylureidotoluene (EHUT), ethylhexylureidotrimethylbenzene (EHUTMB) and ethylhexylureidoxylene (EHUX), preferably the bis-ureas of formula (I) are EHUTMB molecules.

According to one embodiment, the bis-ureas functionalised by macromolecular chains of formula (II) are selected from poly(isobutene)ureidotoluene (PIBUT), poly(isobutene)ureidotrimethylbenzene (PIBUTMB), poly(isobutene)ureidoxylene (PIBOX) and poly(butyl acrylate)ureidoxylene (PABUX); preferably, the functionalised bis-urea is selected from PIBUX and PABUX.

According to one embodiment, the composition comprises the mixture described previously, and at least one solvent, preferably selected from non-polar solvents having long alkyl chains or polar solvents.

The invention also relates to a method for preparing the composition comprising the mixture of conventional bis-ureas of formula (I) and functionalised bis-ureas of formula (II) with at least one solvent, under gentle stirring and optionally in the presence of heating.

According to one embodiment, the solvent is a non-polar solvent having long alkyl chains or an oil.

According to one embodiment, said oil comprises vegetable, animal, mineral or synthetic oils; liquid hydrocarbon combustibles; fuels; lubricants; more preferably PA06 oil.

According to one embodiment, the solvent is a polar solvent.

The invention also relates to the use of the composition as an additive in a cosmetic composition, or an ink, in a fuel or in a lubricant, in particular for automobiles.

In one embodiment, the composition is used as an organogelator, alone or in a cosmetic preparation, an ink, a fuel or a lubricant, in particular for automobiles.

### DEFINITIONS

In the present invention, the following terms are defined as follows:
“Alkene” relates to an unsaturated hydrocarbon chain, linear or branched, comprising 2 to 40 carbon atoms, characterised by the presence of at least one double covalent bond between two carbon atoms;
“Alkyne” relates to an unsaturated hydrocarbon chain, linear or branched, comprising 2 to 40 carbon atoms, characterised by the presence of at least one triple covalent bond between two carbon atoms;
“Alkyl” relates to a linear or branched hydrocarbon chain, optionally substituted, comprising 1 to 40 carbon atoms; preferably the term alkyl including alkyl chains comprising 1 to 9 carbon atoms; in particular methyl, ethyl, propyl, isopropyl, n-butyl, sec-butyl, isobutyl, tert-butyl, pentyl, hexyl, heptyl, octyl, nonyl; the term alkyl also includes long alkyl chains comprising 10 to 40 carbon atoms including in particular decyl, undecyl, dodecyl, tridecyl, tetradecyl, pentadecyl, cetyl, heptadecyl, octadecyl, nonadecyl and eicosyl.
“Non-polar” refers to a solvent, the resultant dipole moment of which is low or zero;
“Aprotic” is said of media or solvents that cannot contain or supply protons;
“Aryl” relates to a mono- or polycyclic system of 5 to 32 atoms, preferably 6 to 14, highly preferably 6 to 10 carbon atoms having one or more aromatic rings. According to the invention, the aryl group is preferably a phenyl group;
“Assembly” or “autoassembly” relates to the association of molecules for the purpose of forming particular structures in a controlled manner. According to the invention, assembly means the association, by weak bonds, preferably by hydrogen bonds, of bis-ureas in solution. According to the invention, these assemblies may lead to filamentary or tubular structures; preferably to tubular assemblies;
“Biofuel” or “biodiesel” relates to any fuel obtained from vegetable or animal oil (including used cooking oils) transformed by transesterification with an alcohol (mainly methanol or ethanol) in order to obtain a vegetable oil methyl ester (VOME) or a vegetable oil ethyl ester (VOEE);
“Bis-urea” relates to a chemical molecule having two urea functions; the urea function being defined as the functional group —NH—CO—NH—;
“Fuel” relates to a fuel for a heat engine converting chemical energy into mechanical energy. Conventional fuels are liquids coming mainly from petroleum and supplying several types of product (petrol, fuel oil, jet fuel, etc.) intended to supply a heat engine. The fuels may be used in very different vehicles (cars, aeroplanes, ships, etc.). Fuels also comprise fuels issuing from biomass (biofuels), from the Fischer-Tropsch process using coal as the raw material or from the modified Fischer-Tropsch process (or GTL “gas to liquids” method) using natural coal gas as the raw material;
“Macromolecular chain” relates to a molecule with a high molecular molar mass, consisting of the repetition of a basic unit. In the present invention, macromolecular chains may be of organic or mineral origin; preferably organic. According to the invention, macromolecular chains may be of natural or synthetic origin; preferably, these chains are of synthetic origin and are selected from the family comprising polyacrylates, polymethacrylates, polyolefins, polycarbonates, polyethers, polydienes, polyvinyl acetates, polycarbonates, polysiloxanes, polyesters, polynorbornenes, polycyclooctenes and polystyrenes. Preferably, the macromolecular chains are polyisobutene and poly(butyl acrylate);
“Combustible” refers to a material capable of burning in contact with oxygen or a gas containing oxygen, producing a quantity of usable heat;
“Unhindered” refers to the spacer of a bis-urea substituted in positions 1 and 3 by urea functions; said spacer being optionally substituted by one or two groups, each independently selected from halogens, alkyls, alkenes, alkynes, heteroalkyls, heteroalkenes or heteroalkynes; preferably the spacer of an “unhindered” bis-urea is a phenyl group substituted in positions 1 and 3 by urea functions and optionally substituted in position 4 or in positions 4 and 6;
“Hindered” refers to the spacer of a bis-urea substituted in positions 1 and 3 by urea functions and substituted by three or four groups, each independently selected from halogens, alkyls, alkenes, alkynes, heteroalkyls, heteroalkenes or heteroalkynes; preferably, the spacer is a phenyl group substituted in positions 1 and 3 by urea functions and substituted by at least three groups selected from alkyl chains comprising 1 to 4 carbon atoms and halogens selected from Cl or Br;
“Spacer” relates to the chemical group separating the two urea functions in a bis-urea molecule; according to the invention, the spacer relates to an aryl or heteroaryl group substituted in particular by two urea functions respectively in positions 1 and 3 of the aryl or heteroaryl group;
“Complementary spacers”: within the meaning of the invention, a mixture of bis-ureas provides complementary spacers when it comprises bis-ureas with an unhindered spacer and bis-ureas with a hindered spacer;
“About”: placed in front of a number, this term signifies plus or minus 10% of the nominal value of the number;
“Gel” or “physical gel” relates to a solid three-dimensional lattice formed by physical interactions between chemical entities diluted in a fluid. A gel may have properties ranging from soft and ductile to hard and fragile. In particular, a gel is considered to be stable when it does not exhibit any flow. In the present invention, the term “gel” or “physical gel” designates any solid three-dimensional architecture obtained by autoassembly by intermolecular hydrogen bonds of conventional bis-ureas or bis-ureas functionalised by macromolecular chains;
“Halogen” relates to a chemical element selected from the 17^{th} column of the periodic table; preferably Cl or Br;
“Heteroalkene” relates to an alkene chain having at least one atom different from a carbon or hydrogen atom; preferably said atom being selected from N, S, P or O;
“Heteroalkyne” relates to an alkyne chain having at least one atom different from a carbon or hydrogen atom; preferably said atom being selected from N, S, P or O;
“Heteroalkyl” relates to an alkyl group having at least one atom different from a carbon or hydrogen atom; preferably said atom being selected from N, S, P or O;
“Heteroaryl” relates to an aryl group having at least one atom different from a carbon or hydrogen atom; preferably said atom being selected from N, S, P or O;
“Oil” relates to a fatty substance, liquid at ambient temperature and insoluble in water. It may be of synthetic, vegetable, animal or mineral origin;
“Long alkyl chains” refers to non-polar solvents having alkyl chains comprising at least 10 carbon atoms; preferably comprising 12 to 40 carbon atoms;
“Lubricant” relates to a fatty substance comprising a compound or a mixture of compounds, intended to reduce the phenomena of friction or abrasion when it is introduced between two solid bodies. In particular, the term lubricant comprises all lubricants for mechanical or anatomical use;
“Polar” is said of a molecule or solvent having a non-zero resultant dipole moment;
“Protic” relates to a chemical entity capable of forming an H⁺ ion in its environment;
“Reversible” or “thermoreversible”: according to the invention, the composition has a reversible (or thermoreversible) gel/liquid behaviour depending on whether its temperature is below (gel) or above (liquid) its gel/liquid temperature; a reversible composition within the meaning of the invention is a composition that can change indefinitely from the gel state to a liquid state or from a liquid state to a gel state according to its temperature;
“Ambient temperature” relates to the temperature of the surrounding environment. According to the invention, the ambient temperature is 20° C.±5° C.;
“Gel/liquid transition temperature” relates to the particular temperature of change of phase of a compound or a mixture of compounds, characterising the change from a gel state to a liquid state.

### DETAILED DESCRIPTION

The present invention relates to a mixture or a composition comprising a mixture of conventional bis-ureas and bis-ureas functionalised by macromolecular chains, wherein:

the conventional bis-ureas are of general formula (I),

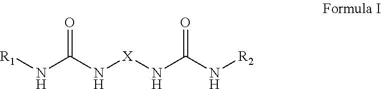

wherein

X represents a group selected from aryl or heteroaryl groups; optionally substituted by one or more groups selected from halogens, alkyls, alkenes, alkynes, heteroalkyls, heteroalkenes or heteroalkynes; preferably, X represents a phenyl group substituted by at least one alkyl chain comprising 1 to 4 carbon atoms and/or at least one halogen selected from Cl or Br;

R₁ and R₂ each represent independently a linear or branched group, selected from alkyl, alkene, alkyne, aryl, arylalkyl, heteroaryl, heteroalkyl, heteroalkene or heteroalkyne; said linear or branched group optionally being substituted by a halogen, alkyl, alkene, alkyne, heteroalkyl, heteroalkene or heteroalkyne group;

the bis-ureas functionalised by macromolecular chains are of general formula (II)

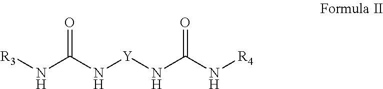

wherein

Y represents a group selected from aryl or heteroaryl groups; optionally substituted by one or more groups selected from halogens, alkyls, alkenes, alkynes, heteroalkyls, heteroalkenes or heteroalkynes; preferably, Y represents a phenyl group substituted by at least one alkyl chain comprising 1 to 4 carbon atoms or at least one halogen selected from Cl or Br;

at least one of R₃ and R₄ represents a macromolecular chain, preferably selected from the family comprising polyacrylates, polymethacrylates, polyolefins, polycarbonates, polyethers, polydienes, polyvinyl acetates, polycarbonates, polysiloxanes, polyesters, polynorbornenes, polycyclooctenes and polystyrenes; and the other one of R₃ and R₄ represents a linear or branched group, selected from alkyl, alkene, alkyne, aryl, arylalkyl, heteroaryl, heteroalkyl, heteroalkene or heteroalkyne; said linear or branched group optionally being substituted by a halogen, alkyl, alkene, alkyne, heteroalkyl, heteroalkene or heteroalkyne group, or a macromolecular chain, preferably selected from the family comprising polyacrylates, polymethacrylates, polyolefins and polystyrenes; preferably R₃ and R₄ are identical; more preferably R₃ and R₄ are identical and each represent a macromolecular chain of poly(isobutene) or poly(butyl acrylate);

and

X and Y are complementary spacers.

According to one embodiment, the invention relates to a mixture or a composition consisting of a mixture of conventional bis-ureas, bis-ureas functionalised by macromolecular chains and a solvent, wherein:

the conventional bis-ureas are of general formula (I),

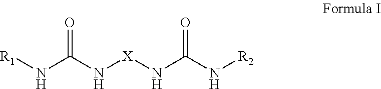

wherein X, R₁ and R₂ are defined as before, and

the bis-ureas functionalised by macromolecular chains are of general formula (II)

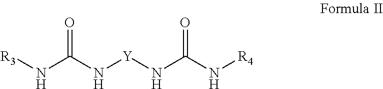

wherein Y, R₃ and R₄ are defined as before,

and X and Y are complementary spacers.

According to one embodiment, said conventional bis-ureas of formula (I) are selected from ethylhexylureidotoluene (EMUT), ethylhexylureidotrimethylbenzene (EHUTMB) and ethylhexylureidoxylene (EHUX).

According to a preferred embodiment, the ethylhexylureidotoluene (EHUT) is ethylhexylureido-4-methylbenzene of formula

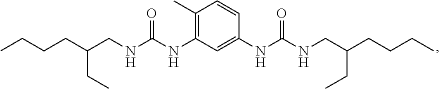 [SMILES: CCCCC(CC)CNC(=O)Nc1ccc(C)c(NC(=O)NCC(CC)CCCC)c1]

According to a preferred embodiment, the ethylhexylureidotrimethylbenzene (EHUTMB) is ethylhexylureido-2,4,6-trimethylbenzene of formula

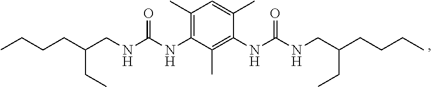 [SMILES: CCCCC(CC)CNC(=O)Nc1c(C)cc(C)c(NC(=O)NCC(CC)CCCC)c1C]

According to a preferred embodiment, the ethylhexylureidoxylene (EHUX) is ethylhexylureido-4,6-dimethylbenzene of formula

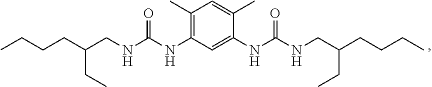 [SMILES: CCCCC(CC)CNC(=O)Nc1cc(NC(=O)NCC(CC)CCCC)c(C)cc1C]

According to one embodiment, the bis-ureas functionalised by macromolecular chains of formula (II) are selected from oligomers, polymers or copolymers selected from the family comprising polyacrylates, polymethacrylates, polyolefins, polycarbonates, polyethers, polydienes, polyvinyl acetates, polycarbonates, polysiloxanes, polyesters, polynorbornenes, polycyclooctenes and polystyrenes.

In one embodiment, said macromolecular chains are selected according to the nature of the solvent.

According to one embodiment, the macromolecular chains functionalising the bis-ureas of formula (II) are selected so as to facilitate the solubilisation of the conventional bis-ureas of formula (I) in solvents wherein these bis-ureas are not or only slightly soluble.

According to one embodiment, the macromolecular chains functionalising the bis-ureas of formula (II) are selected so as to stabilise the autoassemblings of the bis-ureas in solvents wherein the conventional bis-ureas of formula (I) do not form a gel; preferably in solvents wherein the bis-ureas do not form a gel that is stable over time or stable under temperature.

According to one embodiment, the macromolecular chains are selected from polyisobutene chains when the solvent is selected from non-polar solvents, in particular selected from non-polar solvents comprising long alkyl chains; in particular comprising dodecane, tridecane, tetradecane, pentadecane, cetane, heptadecane, octadecane, nonadecane, eicosane, heneicosane, docosane, tricosane, tetracosane, pentacosane, hexacosane, heptacosane, octacosane, nonacosane, triacontane, untriacontane, dotriacontane, tritriacontane, tetratriacontane, pentatriacontane, hexatriacontane, heptatriacontane, octatriacontane, nanotriacontane, tetracontane; preferably when the solvent selected is dodecane.

According to one embodiment, the macromolecular chains are poly(butyl acrylate) chains when the solvent is selected from polar solvents; preferably when the solvent is selected in particular from tetrahydrofuran (THF) or ethylacetate.

According to one embodiment, the macromolecular chains are polyethylene oxide (PEO) chains when the solvent is selected from water, alcohols or acetonitrile.

According to one embodiment, the macromolecular chains have a number average molar mass Mₙ of between 300 and 100,000 g/mol.

According to one embodiment, the macromolecular chains have a number degree of polymerisation DPₙ of between 2 and 1000; preferably from 90 and 200; more preferably from 13 and 35.

The number degree of polymerisation DPₙ is equal to the ratio of the number average molar mass of the macromolecular chains, Mₙ, to the molar mass of the monomer unit (also referred to as the repetition unit) M₀.

According to one embodiment, said bis-ureas functionalised by macromolecular chains, of formula (II), are poly(isobutene)ureidotoluenes (PIBUTs); preferably the functionalised bis-ureas are poly(isobutene)ureido-4-methylbenzenes of formula

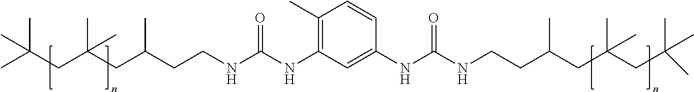

where n represents an integer number from 2 to 1000; preferably n is an integer number from 5 to 50.

According to one embodiment, said bis-ureas functionalised by macromolecular chains, of formula (II), are poly(isobutene)ureidotrimethylbenzenes (PIBUTMBs); preferably, said functionalised bis-ureas are poly(isobutene)ureido-2,4,6-trimethylbenzenes of formula

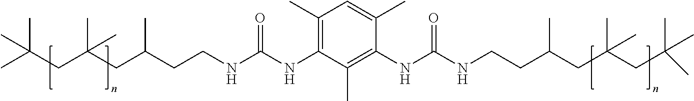

where n represents an integer number from 2 to 1000; preferably n is an integer number from 5 to 50.

According to one embodiment, said bis-ureas functionalised by macromolecular chains, of formula (II), are poly(isobutene)ureidoxylenes (PIBIXs); preferably, said functionalised bis-ureas are poly(isobutene)ureido-4,6-dimethylbenzenes of formula

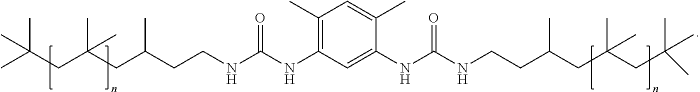

where n represents an integer number from 2 to 1000; preferably n is an integer number from 5 to 50.

According to one embodiment, said bis-ureas functionalised by macromolecular chains, of formula (II), are poly(butyl acrylate)ureidoxylenes (PABUXs); preferably, said functionalised bis-ureas are poly(butyl acrylate)ureido-4,6-dimethylbenzenes of formula

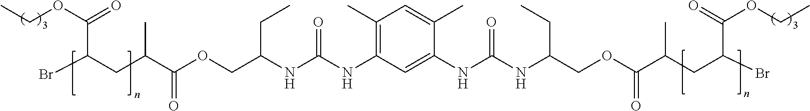

where n represents an integer number from 2 to 1000; preferably n is an integer number from 5 to 50.

According to one embodiment, said bis-ureas functionalised by macromolecular chains, of formula (II), are poly(butyl acrylate)ureidoxylene (PABUXs); preferably, said functionalised bis-ureas are poly(butyl acrylate)ureido-4,6-dimethylbenzenes of formula

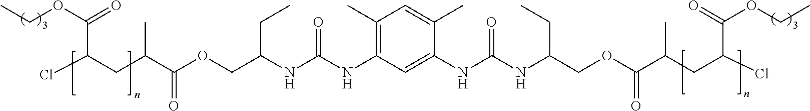

where n represents an integer number from 2 to 1000; preferably n is an integer number from 5 to 50.

According to one embodiment, said bis-ureas functionalised by macromolecular chains, of formula (II), are poly(ethylene oxide)ureidoxylenes (POEUXs); preferably, said functionalised bis-ureas are poly(ethylene oxide)ureido-4,6-dimethylbenzenes of formula

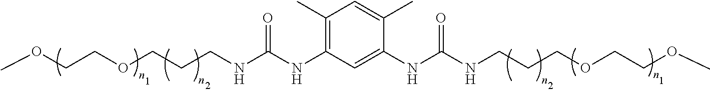

where n₁ and n₂ each represent independently an integer number from 2 to 1000; preferably n₁ and n₂ each represent independently an integer number from 2 to 50.

According to one embodiment, n₁ represents an integer number from 2 to 20. According to one embodiment, n₂ represents an integer number from 2 to 20.

According to one embodiment, the mixture or the composition comprising the mixture comprises an unhindered spacer X and a hindered spacer Y.

According to one embodiment, the mixture or the composition comprising the mixture comprises a hindered spacer X and an unhindered spacer Y.

According to one embodiment, an unhindered spacer is a phenyl group substituted in positions 1 and 3 by urea functions; said phenyl group optionally being substituted also by one or two groups, each independently selected from halogens, alkyls, alkenes, alkynes, heteroalkyls, heteroalkenes or heteroalkynes; preferably selected from an alkyl chain comprising 1 to 4 carbon atoms and/or a halogen selected from Cl or Br. In one embodiment, the unhindered spacer is a phenyl group substituted in positions 1 and 3 by urea functions and not substituted on the other positions. In one embodiment, the unhindered spacer is a phenyl group substituted in positions 1 and 3 by urea functions and not substituted in position 2. In one embodiment, the unhindered spacer is a phenyl group substituted in positions 1 and 3 by urea functions and substituted in position 4 by Cl, Br or a methyl group. In one embodiment, the unhindered spacer is a phenyl group substituted in positions 1 and 3 by urea functions and substituted in position 4 by Cl. In one embodiment, the unhindered spacer is a phenyl group substituted in positions 1 and 3 by urea functions and substituted in position 4 by Br. In one embodiment, the unhindered spacer is a phenyl group substituted in positions 1 and 3 by urea functions and substituted in position 4 by a methyl group. In one embodiment, the unhindered spacer is a phenyl group substituted in positions 1 and 3 by urea functions and substituted in position 4 and 6 by Cl, Br or a methyl group. In one embodiment, the unhindered spacer is a phenyl group substituted in positions 1 and 3 by urea functions and substituted in positions 4 and 6 by Cl. In one embodiment, the unhindered spacer is a phenyl group substituted in positions 1 and 3 by urea functions and substituted in positions 4 and 6 by Br. In one embodiment, the unhindered spacer is a phenyl group substituted in positions 1 and 3 by urea functions and substituted in positions 4 and 6 by a methyl group.

According to one embodiment, a hindered spacer is a phenyl group substituted in positions 1 and 3 by urea functions and substituted by three or four groups, each independently selected from halogens, alkyls, alkenes, alkynes, heteroalkyls, heteroalkenes or heteroalkynes; preferably selected from alkyl chains comprising 1 to 4 carbon atoms and the halogens selected from Cl or Br. In one embodiment, the hindered spacer is a phenyl group substituted in positions 1 and 3 by urea functions and substituted on all the other positions. In one embodiment, the hindered spacer is a phenyl group substituted in positions 1 and 3 by urea functions and substituted in positions 2, 4 and 6 by Cl, Br or a methyl group. In one embodiment, the hindered spacer is a phenyl group substituted in positions 1 and 3 by urea functions and substituted in positions 2, 4 and 6 by Cl. In one embodiment, the hindered spacer is a phenyl group substituted in positions 1 and 3 by urea functions and substituted in positions 2, 4 and 6 by Br. In one embodiment, the hindered spacer is a phenyl group substituted in positions 1 and 3 by urea functions and substituted in positions 2, 4 and 6 by a methyl group.

According to one embodiment, the spacer is selected from the benzyl, tolyl, xylyl or trimethylbenzyl groups; optionally substituted by one or more halogen groups, preferably by one or more Cl or Br atoms.

The present invention also relates to bis-ureas functionalised by macromolecular chains of general formula (III):

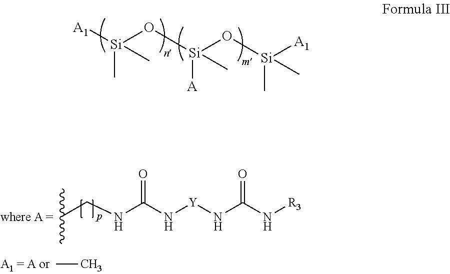

wherein

Y represents a group selected from aryl or heteroaryl groups; optionally substituted by one or more groups selected from halogens, alkyls, alkenes, alkynes, heteroalkyls, heteroalkenes or heteroalkynes; preferably, Y represents a phenyl group substituted by at least one alkyl chain comprising 1 to 4 carbon atoms and/or at least one halogen selected from Cl or Br;

R₃ represents a linear or branched group, selected from alkyl, alkene, alkyne, aryl, arylalkyl, heteroaryl, heteroalkyl, heteroalkene or heteroalkyne; said linear or branched group optionally being substituted by a halogen, alkyl, alkene, alkyne, heteroalkyl, heteroalkene or heteroalkyne group, or a macromolecular chain, preferably selected from the family comprising polyacrylates, polymethacrylates, polyolefins and polystyrenes; preferably R₃ is a phenyl group substituted by an alkyl chain; more preferably R₃ is the butylbenzyl group;

p represents an integer number from 1 to 1000; preferably p is an integer number from 2 to 50; more preferably p is equal to 3;

n′ represents an integer number from 1 to 1000; preferably n′ is an integer number from 2 to 500;

m′ represents an integer number from 0 to 1000.

According to one embodiment, m′ represents an integer number equal to 0.

According to one embodiment, said bis-ureas functionalised by macromolecular chains of formula (III) are polydimethylsiloxaneureidotoluenes (PDMSUTs), preferably the polydimethylsiloxaneureidotoluenes of formula:

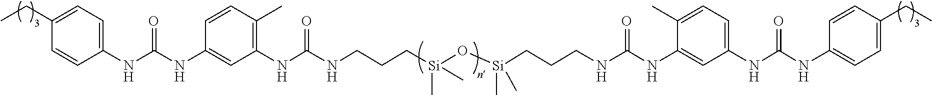

wherein n′ represents an integer number from 1 to 1000; preferably n′ is an integer number from 2 to 500.

The present invention also relates to a mixture or a composition comprising a mixture of conventional bis-ureas and bis-ureas functionalised by macromolecular chains, wherein:

the conventional bis-ureas are of general formula (I),

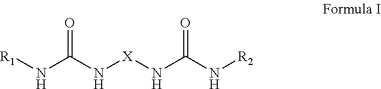

wherein X, R₁ and R₂ are defined as previously;

the bis-ureas functionalised by macromolecular chains are of general formula (III),

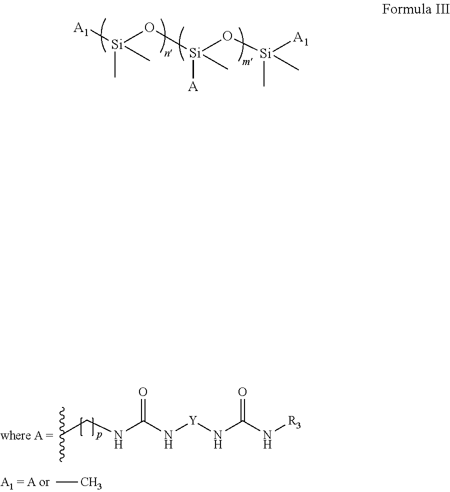

wherein Y, R₃, p, n′ and m′ are defined as previously; and

X and Y are complementary spacers.

According to one embodiment, the macromolecular chains functionalising the bis-ureas of formula (III) are selected so as to stabilise the autoassemblings of the bis-ureas in solvents wherein the conventional bis-ureas of formula (I) do not form a gel; preferably in solvents wherein the bis-ureas do not form a gel that is stable over time or stable under temperature.

According to one embodiment, the invention relates to a mixture or a composition consisting of a mixture of conventional bis-ureas, bis-ureas functionalised by macromolecular chains and a solvent, wherein:

the conventional bis-ureas are of general formula (I),

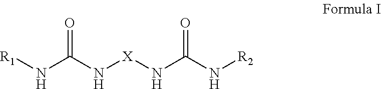

wherein X, R₁ and R₂ are defined as previously; and

the bis-ureas functionalised by macromolecular chains are of general formula (III),

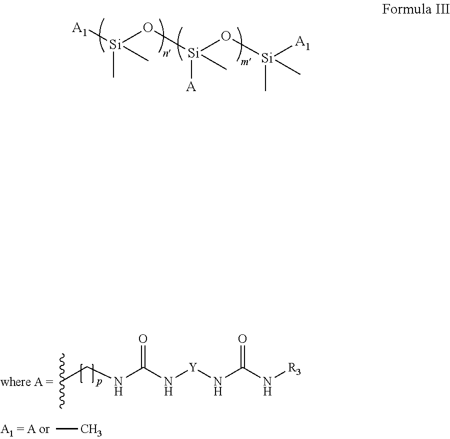

wherein Y, R₃, p, n′ and m′ are defined as previously;

and X and Y are complementary spacers.

According to one embodiment, the mixtures or the compositions comprising the mixtures of bis-ureas having complementary spacers X and Y are described in the following table:

| | | Spacer Y of functionalised bis- |
|---|---|---|
| Mixture | Spacer X of cenventional bis- | ureas of formula |
| No. | ureas of formula (I) | (II) or formula (III) |
| 1 | 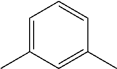 | 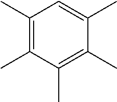 |
| 2 | 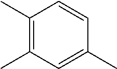 | 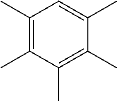 |
| 3 | 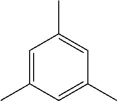 | 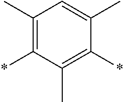 |
| 4 | 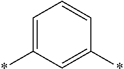 [SMILES: *c1cccc(*)c1] | 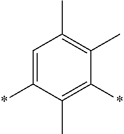 [SMILES: *c1cc(C)c(C)c(*)c1C] |
| 5 | 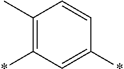 [SMILES: *c1ccc(C)c(*)c1] | 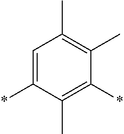 [SMILES: *c1cc(C)c(C)c(*)c1C] |
| 6 | 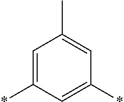 [SMILES: *c1cc(*)cc(C)c1] | 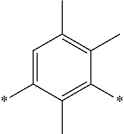 [SMILES: *c1cc(C)c(C)c(*)c1C] |
| 7 | 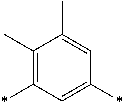 [SMILES: *c1cc(*)c(C)c(C)c1] | 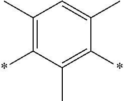 [SMILES: *c1c(C)cc(C)c(*)c1C] |
| 8 | 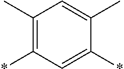 [SMILES: *c1cc(*)c(C)cc1C] | 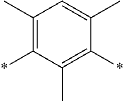 [SMILES: *c1c(C)cc(C)c(*)c1C] |
| 9 | 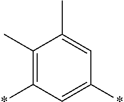 [SMILES: *c1cc(*)c(C)c(C)c1] | 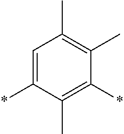 [SMILES: *c1cc(C)c(C)c(*)c1C] |
| 10 | 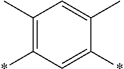 [SMILES: *c1cc(*)c(C)cc1C] | 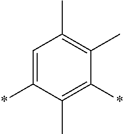 [SMILES: *c1cc(C)c(C)c(*)c1C] |
| 11 | 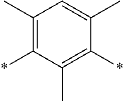 [SMILES: *c1c(C)cc(C)c(*)c1C] | 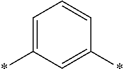 [SMILES: *c1cccc(*)c1] |
| 12 | 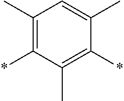 [SMILES: *c1c(C)cc(C)c(*)c1C] | 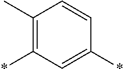 [SMILES: *c1ccc(C)c(*)c1] |
| 13 | 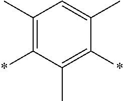 [SMILES: *c1c(C)cc(C)c(*)c1C] | 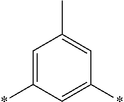 [SMILES: *c1cc(*)cc(C)c1] |
| 14 | 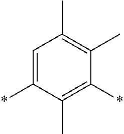 [SMILES: *c1cc(C)c(C)c(*)c1C] | 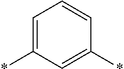 [SMILES: *c1cccc(*)c1] |
| 15 | 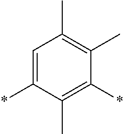 [SMILES: *c1cc(C)c(C)c(*)c1C] | 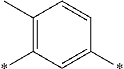 [SMILES: *c1ccc(C)c(*)c1] |
| 16 | 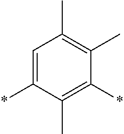 [SMILES: *c1cc(C)c(C)c(*)c1C] | 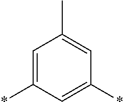 [SMILES: *c1cc(*)cc(C)c1] |
| 17 | 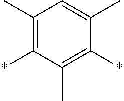 [SMILES: *c1c(C)cc(C)c(*)c1C] | 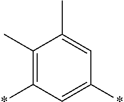 [SMILES: *c1cc(*)c(C)c(C)c1] |
| 18 | 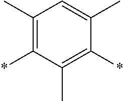 [SMILES: *c1c(C)cc(C)c(*)c1C] | 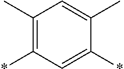 [SMILES: *c1cc(*)c(C)cc1C] |
| 19 | 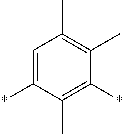 [SMILES: *c1cc(C)c(C)c(*)c1C] | 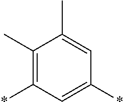 [SMILES: *c1cc(*)c(C)c(C)c1] |
| 20 | 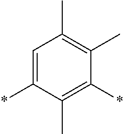 [SMILES: *c1cc(C)c(C)c(*)c1C] | 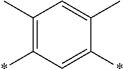 [SMILES: *c1cc(*)c(C)cc1C] |
| 21 | 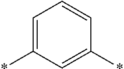 [SMILES: *c1cccc(*)c1] | 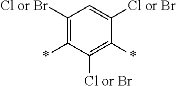 |
| 22 | 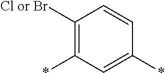 | 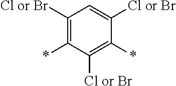 |
| 23 | 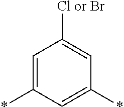 | 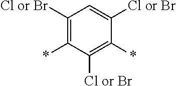 |
| 24 | 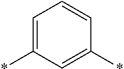 [SMILES: *c1cccc(*)c1] | 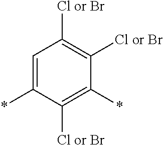 |
| 25 | 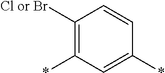 | 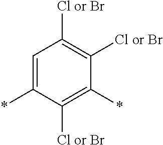 |
| 26 | 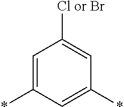 | 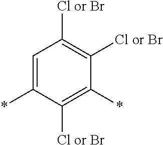 |
| 27 | 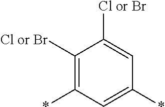 | 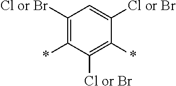 |
| 28 | 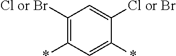 | 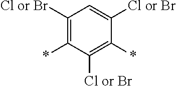 |
| 29 | 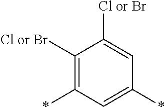 | 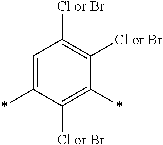 |
| 30 | 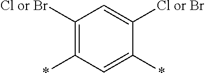 | 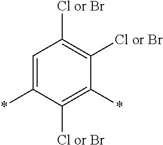 |
| 31 | 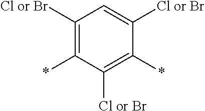 | 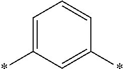 [SMILES: *c1cccc(*)c1] |
| 32 | 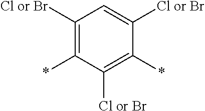 | 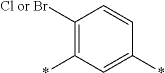 |
| 33 | 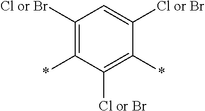 | 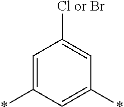 |
| 34 | 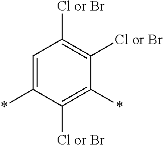 | 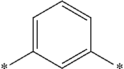 [SMILES: *c1cccc(*)c1] |
| 35 | 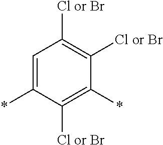 | 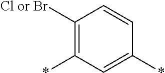 |
| 36 | 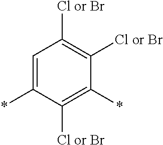 | 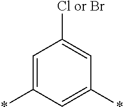 |
| 37 | 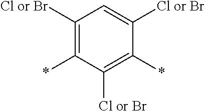 | 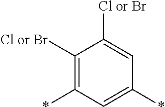 |
| 38 | 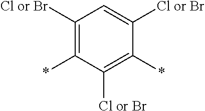 | 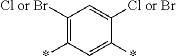 |
| 39 | 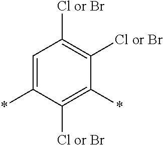 | 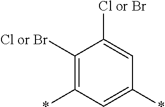 |
| 40 | 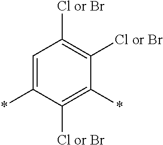 | 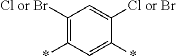 |

*Position of the urea functions.

[Translation of captions in Table: Cl ou Br═Cl or Br]

According to one embodiment, the mixture of the invention comprises:

conventional bis-ureas of general formula (I)

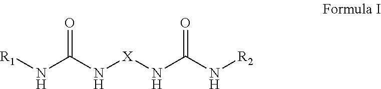

wherein

X represents a hindered spacer; preferably a trimethylbenzene group;

R₁ and R₂ are defined as previously; and

bis-ureas functionalised by macromolecular chains, of general formula (II)

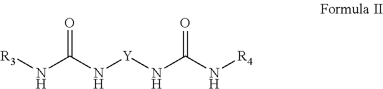

wherein

Y represents an unhindered spacer: preferably a toluene or xylene group;

R₃ and R₄ are defined as previously.

According to one embodiment, the mixture of the invention comprises:

conventional bis-ureas of general formula (I)

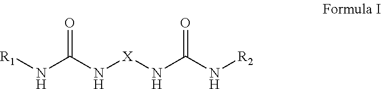

wherein

X represents an unhindered spacer: preferably a toluene or xylene group;

R₁ and R₂ are defined as previously;

bis-ureas functionalised by macromolecular chains, of general formula (II)

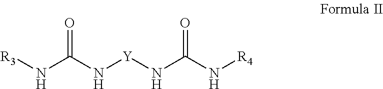

wherein

Y represents a hindered spacer; preferably a trimethylbenzene group;

R₃ and R₄ are defined as previously.

According to one embodiment, the mixture or the composition comprising the mixture of conventional bis-ureas of formula (I) and functionalised bis-ureas of formula (II) leads to a stable gel, the gel/liquid transition temperature of which is higher than that of a solution obtained from said conventional bis-ureas alone.

According to one embodiment, the mixture or the composition comprising the mixture of conventional bis-ureas of formula (I) and functionalised bis-ureas of formula (III) leads to a stable gel, the gel/liquid transition temperature of which is higher than that of a solution obtained from said conventional bis-ureas alone.

In one embodiment, the mixture of the invention comprises from 1% to 99% mol functionalised bis-ureas of formula (II) or of formula (III) with respect to the total molar quantity of bis-ureas; preferably from 10% mol to 90% mol with respect to the total molar quantity of bis-ureas; more preferably 50% with respect to the total molar quantity of bis-ureas.

According to the present invention, the preferred mixtures correspond to the following molar compositions of the conventional bis-ureas of formula (I)/functionalised bis-ureas of formula (II) (% mol/% mol): 10/90; 20/80; 30/70; 40/60; 50/50; 60/40; 70/30; 80/20 and 90/10.

According to the present invention, the preferred mixtures correspond to the following molar compositions of the conventional bis-ureas of formula (I)/functionalised bis-ureas of formula (III) (% mol/% mol): 10/90; 20/80; 30/70; 40/60; 50/50; 60/40; 70/30; 80/20 and 90/10.

According to one embodiment, the mixture of the invention comprises an equimolar mixture of the conventional bis-ureas of formula (I) and functionalised bis-ureas of formula (II).

According to one embodiment, the mixture of the invention comprises an equimolar mixture of the conventional bis-ureas of formula (I) and functionalised bis-ureas of formula (III).

In one embodiment, the content by mass of bis-ureas in the mixture or the composition comprising the mixture is 0.1% to 10% by mass with respect to the total mass of the composition; preferably the content by mass of bis-ureas is less than or equal to 10%; more preferably the content by mass of bis-ureas is about 0.4%; 0.5% or 1% by mass with respect to the total mass of the composition.

In one embodiment, the molar concentration of bis-ureas in the mixture of the invention is 0.001 to 0.1 mol/l; preferably from 0.002 to 0.008 mol/l; more preferably the molar concentration of bis-ureas in the composition is about 5 mmol/l.

In one embodiment, the mixture or the composition comprising the mixture is able to form a physical gel when said mixture is made at a temperature below the gel/liquid transition temperature characterising said mixture of bis-ureas. Said gel/liquid transition temperature varies for each mixture of bis-ureas according to its composition and/or the presence of solvent.

According to one embodiment, the mixture of the invention has a gel/liquid transition temperature higher than ambient temperature; preferably, said gel/liquid transition temperature is above 40° C.; preferably the gel/liquid transition temperature is above 70° C.; more preferably the gel/liquid transition temperature is about 100° C.

According to one embodiment, said gel/liquid transition temperature is below ambient temperature; preferably said gel/liquid transition temperature is below 15° C.

According to one embodiment, the mixture of the invention is able to form a physical gel when the mixing is carried out at ambient temperature.

According to one embodiment, the mixture of the invention is able to form a liquid when the mixture is heated to a temperature above its gel/liquid transition temperature.

According to one embodiment, the mixture or the composition comprising the mixture has a reversible behaviour between a physical gel state and a liquid state; more particularly the composition is thermoreversible.

Without wishing to be bound by any particular theory, the Applicant thinks that the possibility of obtaining a gel at ambient temperature, with or without heating, from the mixture of conventional bis-ureas and bis-ureas functionalised by macromolecular chains results both from a solubilisation improved by the introduction of bis-ureas having macromolecular chains in the middle, and from a synergic effect between the various spacers of the bis-ureas making it possible to stabilise the assemblies of bis-ureas in solution.

The present invention also relates to a composition comprising:

a mixture of conventional bis-ureas of formula (I) and bis-ureas functionalised by macromolecular chains of formula (II) or of formula (III) as described previously,

and at least one solvent.

In one embodiment, the solvent of the composition is selected from protic polar liquids, aprotic polar liquids and aprotic non-polar liquids.

According to one embodiment, the solvent is selected from non-polar solvents, preferably non-polar solvents containing long alkyl chains or an oil; more preferably, non-polar solvents containing long alkyl chains.

According to one embodiment, the solvent of the composition is selected from solvents comprising long alkyl chains such as dodecyl, tridecyl, tetradecyl, pentadecyl, cetyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, untriacontyl, dotriacontyl, tritriacontyl, tetratriacontyl, pentatriacontyl, hexatriacontyl, heptatriacontyl, octatriacontyl, nonatriacontyl and tetracontyl.

According to one embodiment, the solvent is selected from polar solvents, preferably water, acetonitrile, chloroform, 1,2-dimethoxyethane, N,N-dimethylacetamide, N,N-dimethylformamide, tetrahydrofuran or ethylacetate.

According to one embodiment, the solvent is an oil or a mixture of oils selected from vegetable, animal, mineral or synthetic oils; preferably from liquid hydrocarbon combustibles, fuels or lubricants; more preferably the solvent is PA06 oil.

According to one embodiment, the solvent is a silicone oil; preferably decamethylcyclopentasiloxane (D5).

The invention also relates to a method for preparing a composition comprising a mixing under gentle stirring, and optionally in the presence of heating:

of conventional bis-ureas of general formula (I),

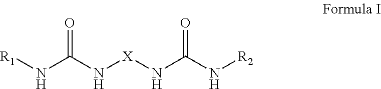

wherein X, R₁ and R₂ are defined as previously;

bis-ureas functionalised by macromolecular chains, of general formula (II)

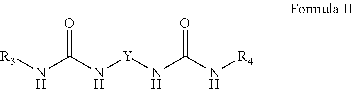

wherein Y, R₃ and R₄ are defined as previously;

and a solvent.

More particularly, the present invention relates to a method of obtaining a composition, under stirring, and optionally in the presence of heating, comprising the following steps:

preparing a mother solution S₁ comprising conventional bis-ureas of formula (I) and a solvent wherein said conventional bis-ureas are soluble,

preparing a mother solution S₂ comprising functionalised bis-ureas of formula (II) and at least one solvent wherein said functionalised bis-ureas are soluble, identical to or different from that of the solution S₁,

a step of mixing solutions S₁ and S₂.

The invention also relates to a method for preparing a composition comprising a mixing under gentle agitation, and optionally in the presence of heating:

of conventional bis-ureas of general formula (I)

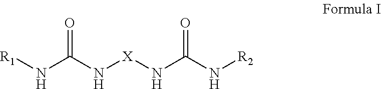

wherein X, R₁ and R₂ are defined as previously;

bis-ureas functionalised by macromolecular chains, of general formula (III)

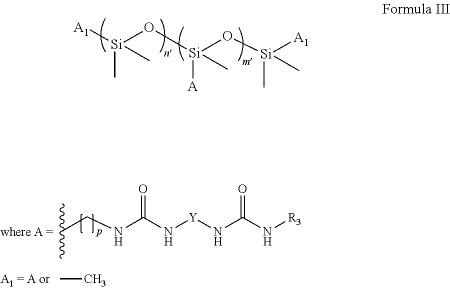

wherein Y, R₃, p, n′ and m′ are defined as previously;

and a solvent.

More particularly, the present invention relates to a method for obtaining a composition, under agitation, and optionally in the presence of heating, comprising the following steps:

preparing a mother solution S₁ comprising conventional bis-ureas of formula (I) and a solvent wherein said conventional bis-ureas are soluble,

preparing a mother solution S₂ comprising functionalised bis-ureas of formula (III) and at least one solvent wherein said functionalised bis-ureas are soluble, identical to or different from that of the solution S₁,

a step of mixing solutions S₁ and S₂.

According to one embodiment, the mother solutions S₁ and S₂ do not individually form a gel that is stable over time or stable under temperature.

According to one embodiment, only the step of mixing the mother solutions S₁ and S₂ leads to a physical gel; preferably a gel stable over time at a temperature below the gel/liquid transition temperature. According to one embodiment, only the step of mixing the mother solutions S₁ and S₂ leads to the formation of a gel by tubular autoassembly of the bis-ureas by intermolecular hydrogen bonds.

In one embodiment, the concentration by mass of conventional bis-ureas of formula (I) in the mother solution S₁ is between >0 and 150 g/l; preferably the concentration by mass is from 1 to 110 g/l. According to one embodiment, the concentration by mass of conventional bis-ureas of formula (I) in the mother solution S₁ is equal to about 2, 4, 40, 50 or 100 g/l.

In one embodiment, the concentration by mass of conventional bis-ureas of formula (II) in the mother solution S₂ is between >0 and 150 g/l; preferably the concentration by mass is from 1 to 110 g/l. According to one embodiment, the concentration by mass of functionalised bis-ureas of formula (II) in the mother solution S₂ is equal to about 2, 4, 40, 50 or 100 g/l.

In one embodiment, the concentration by mass of functionalised bis-ureas of formula (III) in the mother solution S₂ is between >0 and 150 g/l; preferably the concentration by mass is from 1 to 110 g/l. According to one embodiment, the concentration by mass of functionalised bis-ureas of formula (III) in the mother solution S₂ is equal to anout 2, 4, 40, 50 or 100 g/l.

In one embodiment, the composition of the method of the invention comprises a mixture of bis-ureas comprising 1% to 99% mol functionalised bis-ureas of formula (II) with respect to the total molar quantity of bis-ureas; preferably 10% mol to 90% mol with respect to the total molar quantity of bis-ureas; more preferably about 50% mol with respect to the total molar quantity of bis-ureas.

In one embodiment, the composition of the method of the invention comprises a mixture of bis-ureas comprising 1% to 99% mol functionalised bis-ureas of formula (III) with respect to the total molar quantity of bis-ureas; preferably 10% mol to 90% mol with respect to the total molar quantity of bis-ureas; more preferably about 50% mol with respect to the total molar quantity of bis-ureas.

According to the present invention, the preferred compositions of the method of the invention correspond to mixtures comprising the following molar compositions of conventional bis-ureas of formula (I)/functionalised bis-ureas of formula (II) (% mol/% mol): 10/90; 20/80; 30/70; 40/60; 50/50; 60/40; 70/30; 80/20 and 90/10.

According to the present invention, the preferred compositions of the method of the invention correspond to mixtures comprising the following molar compositions of conventional bis-ureas of formula (I)/functionalised bis-ureas of formula (III) (% mol/% mol): 10/90; 20/80; 30/70; 40/60; 50/50; 60/40; 70/30; 80/20 and 90/10.

In one embodiment, the solvent of the composition is selected from protic polar liquids, aprotic polar liquids and aprotic non-polar liquids.

According to one embodiment, the solvent of the mother solution S₁ is identical to the solvent of the solution S₂.

According to one embodiment, the solvent of the mother solution S₁ is different from the solvent of the solution S₂.

According to one embodiment, the solvent is selected from non-polar solvents, preferably toluene, or very non-polar solvents containing long alkyl chains (C₁₂-C₄₀) comprising decane, undecane, dodecane, tridecane, tetradecane, pentadecane, cetane, heptadecane, octadecane, nonadecane, eicosane, heneicosane, docosane, tricosane, tetracosane, pentacosane, hexacosane, heptacosane, octacosane, nonacosane, triacontane, untriacontane, dotriacontane, tritriacontane, tetratriacontane, pentatriacontane, hexatriacontane, heptatriacontane, octatriacontane, nonatriacontane and tetracontane. According to one embodiment, the solvent is dodecane.

According to one embodiment, the solvent of the method is selected from non-polar solvents, preferably water, acetonitrile, chloroform, 1,2-dimethoxyethane, N,N-dimethylacetamide, N,N-dimethylformamide, tetrahydrofuran or ethyl acetate.

According to one embodiment, the solvent is an oil or a mixture of oils selected from vegetable, animal, mineral or synthetic oils, liquid hydrocarbon combustibles, fuels or lubricants such as diesel, biodiesel and fuel oils.

According to a preferred embodiment, the solvent is PA06 oil.

According to one embodiment, the solvent is a silicone oil; preferably decamethylcyclopentasiloxane (D5).

The invention also relates to the use of the mixture of the invention as described previously for texturing or thickening a product, in particular an oil, a fuel or a lubricant; preferably for manufacturing gels from oils.

According to one embodiment, the mixture of the invention is used as an additive in a cosmetic composition, or an ink, in a fuel or in a lubricant, in particular for automobiles.

According to one embodiment, the mixture of the invention is used as an organogelator, alone or in a cosmetic preparation, an ink, a fuel or a lubricant, in particular for automobiles.

### BRIEF DESCRIPTION OF THE FIGURES

FIG. 1 is a photograph showing solutions of EHUTMB (on the left), PIBUX (on the right) and an EHUTMB/PIBUX mixture (90% mol/10% mol) (at the middle) in solution in dodecane (4 g/l).

FIG. 2A is a photograph showing solutions of EHUTMB (on the right), PABUX (on the left) and equimolar EHUTMB/PABUX mixture (in the middle) in solution in ethyl acetate (50 g/l).

FIG. 2B is a photograph showing solutions of EHUTMB (on the right), PABUX (on the left) and equimolar EHUTMB/PABUX mixture (in the middle) in solution in THF (100 g/l).

FIG. 3 is a graph showing the change in relative viscosities for various solutions in toluene (40 g/l) comprising conventional bis-ureas having a trimethylbenzene spacer (EHUTMB), alone or in association with bis-ureas functionalised by macromolecular chains having either a xylene spacer (PIBUX) or a trimethylbenzene spacer (PIBUTMB).

FIG. 4 presents the infrared spectra of two PIBUX/EHUTMB mixtures (at the top, equimolar composition; at the bottom, PIBUX/EHUTMB composition 10% mol/90% mol in solution in toluene at 4 g/l, taken at various temperatures between 20° C. and 80° C.

FIG. 5 is a graph showing the change in the ratio of the absorption bands of the NH bond of the bis-ureas (3333 cm⁻¹ and 3300 cm⁻¹) as a function of the temperature of the mixture for an equimolar PIBUX/EHUTMB composition in toluene.

FIG. 6 presents the infrared spectra of two EHUTMH/PIBUX mixtures (% mol/% mol) 70/30 (6A) and 90/10 (6B) in dodecane at 4 g/l taken at various temperatures between 20° C. and 110° C.

FIG. 7 is a graph showing the change in the ratio of the absorption bands of the NH bond of the bis-ureas (3333 cm⁻¹ and 3300 cm⁻¹) as a function of the temperature of the mixture for EHUTMB/PIBUX mixtures (% mol/% mol) 30/70 (7A); 40/60 (7B); 60/40 (7C); 70/30 (7D) and 90/10 (7E) in dodecane.

FIG. 8 is a graph showing the change in the relative viscosities of EHUTMB/PIBUX solutions in toluene (2 g/l) at various temperatures.

FIG. 9 presents a change in the moduli of elasticity G′ and G″ of an EHUTMB/PIBUX mixture (90% mol/10% mol) in dodecane (4 g/l).

FIG. 10 is a photograph showing solutions of EHUTMB (on the left), of PDMSUT (on the right) and of an equimolar EHUTMB/PDMSUT mixture (in the middle) in solution in decamethylcyclopentasiloxane (25 g/l).

### EXAMPLES

The present invention will be understood better from a reading of the following examples, which illustrate the invention non-limitatively.

### Example 1: Obtaining Gels from an Equimolar Mixture of Conventional and Functionalised Bis-Ureas in the Presence of a Non-Polar Solvent—Influence of the Spacer

These experiments show that, under certain conditions, it is possible to form stable gels in solvents wherein conventional bis-ureas do not make it possible to obtain gels that are stable over time or to obtain gels having a gel/liquid transition temperature higher than ambient temperature.

Various bis-urea solutions were studied in toluene (5 mM):

solutions of conventional bis-ureas selected from EHUT, EHUTMB or EHUX;

solutions of bis-urea functionalised by poly(isobutene) chains selected from PIBUT, PIBUTMB or PIBUX;

equimolar mixtures of solutions of conventional and functionalised bis-ureas.

### 1.1. Macroscopic Assessment of the Solutions

Table 1 presents the results obtained for these various solutions.

TABLE 1
Rheological behaviour of various bis-urea solutions

| | Absence of | | | |
|---|---|---|---|---|
| Solution | conventional | | | |
| comprising . . . | bis-ureas | EHUT | EHUTMB | EHUX |
| Absence of | — | — | Liquid | — |
| functionalised | | | | |
| bis-ureas | | | | |
| PIBUT | Liquid | Liquid | Gel | Gel |
| PIBUTMB | Liquid | Gel | Liquid | Gel |
| PIBUX | Liquid | Gel | Gel | — |

Surprisingly, the applicant found that:

alone, the conventional EHUT, EHUTMB and EHUX bis-ureas do not make it possible to form gels in toluene;

alone, the bis-ureas functionalised by poly(isobutene) chains (PIBUT, PIBUTMB and PIBUX) do not make it possible to form gels. Without wishing to be bound by any theory, the applicant thinks that the functionalised bis-ureas could not form gels because of the steric hindrance of the macromolecular chains, which prevents tubular autoassembly of functionalised bis-ureas;

equimolar mixing of conventional and functionalised bis-ureas comprising identical spacers, that is to say EHUT/PIBUT mixtures (with a toluene spacer) and EHUTMB/PIBUTMB (with a trimethylbenzene spacer) does not make it possible to form gels;

equimolar mixing of conventional and functionalised bis-ureas comprising different spacers, that is to say the mixtures EHUT/PIBUX, EHUT/PIBUTMB, EHUTMB/PIBUT, EHUTMB/PIBUX, EHUX/PIBUT and EHUX/PIBUTMB, does not make it possible to form stable gels.

Comparable results were obtained in dodecane.

### 1.2. Example of the EHUTMB/PIBUX Mixture in Dodecane

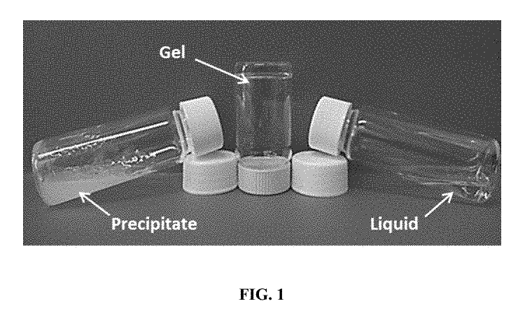

FIG. 1 presents a photograph showing a solution of EHUTMB (on the left), of PIBUX (on the right) and of the EHUTMB/PIBUX mixture (90% mol/10% mol) (in the middle) in dodecane (4 g/l) at ambient temperature.

FIG. 1 shows that the conventional bis-urea EHUTMB is not soluble in dodecane (white precipitate) unlike the functionalised bis-urea PIBUX, which provides a homogeneous solution.

The photograph also shows that the EHUTMB/PIBUX mixture (90% mol/10% mol) of these bis-ureas comprising complementary spacers (a trimethylbenzene spacer for EHUTMB and a xylene spacer for PIBUX) makes it possible to obtain 1) good solubilisation of the EHUTMB bis-ureas in dodecane (no precipitate), and 2) the formation of a gel.

### 1.3. Conclusions

The mixing at ambient temperature of conventional bis-ureas and bis-ureas functionalised by polyisobutene chains having complementary spacers makes it possible 1) to improve the solubilisation of conventional bis-ureas and 2) to provide gels in a solvent wherein, alone, conventional bis-ureas are not soluble or do not form a gel (here in dodecane).

### Example 2: Obtaining Gels from an Equimolar Mixture of Conventional and Functionalised Bis-Ureas in the Presence of a Polar Solvent—Influence of the Spacer

The formation of a gel is obtained by the tubular autoassembly of bis-ureas in solution by means of intermolecular hydrogen bonds. However, depending on the polarity of the solvent, there may exist a competition between the formation of hydrogen bonds between the bis-ureas and the formation of hydrogen bonds between the bis-ureas and the solvent.

This study aims therefore to assess the effect of the complementary spacers of the mixture of bis-ureas on the formation of gel in polar solvents, unfavourable to the association of bis-ureas in solution.

Since polyisobutene chains are insoluble in polar solvents, macromolecular chains of poly(butyl acrylate) were used to functionalise the bis-urea having a xylyl spacer. The bis-urea obtained is the poly(butyl acrylate) ureidoxylene bis-urea (PABUX). The conventional EHUTMB bis-urea has a trimethylbenzene spacer.

### 2.1. In Ethyl Acetate

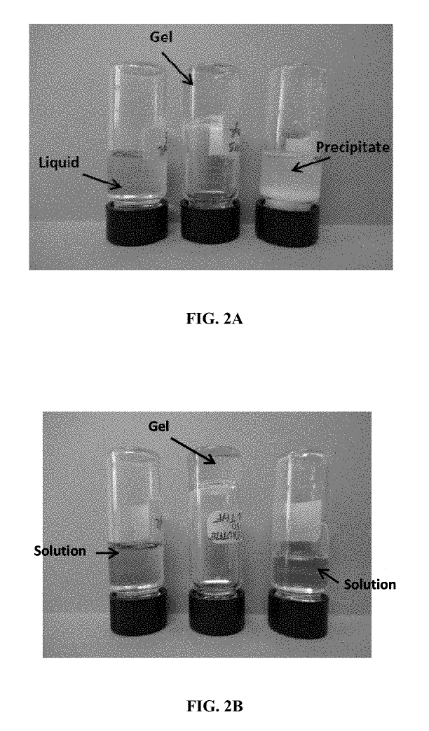

The conventional EHUTMB bis-urea (FIG. 2A, on the right) is not soluble in ethyl acetate at a concentration of 50 g/l, unlike the functionalised bis-urea PABUX for the same concentration, which leads to a clear liquid (FIG. 2A, on the left).

However, it is found that the equimolar EHUTMB/PABUX mixture, at a concentration of 50 g/l, provides a translucent gel that does not flow, even when the sample is turned over (FIG. 2A, in the middle).

### 2.2. In THF

The bis-ureas EHUTMB (FIG. 2B, on the right) and PABUX (FIG. 2B, on the left) are each soluble in THF at a concentration of 100 g/l. However, these bis-urea solutions do not form a gel at ambient temperature; these solutions are liquid.

The equimolar mixture EHUTMB/PABUX, in THF at a concentration of 100 g/l, provided a gel that does not flow, even when the sample is turned over (FIG. 2B, in the middle).

### 2.3. Conclusion

The functionalised bis-urea PABUX promoted the solubilisation of the conventional bis-urea EHUTMB in solvents unfavourable to the formation of gel by hydrogen bonds.

This solution can be compared with that observed for the PIBUX/EHUTMB mixture in dodecane (and when the macromolecular chains are polyisobutene chains) where the hydrogen bonds between bis-ureas were stronger.

It is therefore demonstrated here that the invention covers a wide variety of possibilities, where it is possible to select the nature of the appropriate macromolecular chain for solubilising and stabilising the assemblies of bis-urea in the selected solvent: here poly(butyl acrylate) chains for polar solvents. These assemblies could be solubilised at ambient temperature, which is a certain advantage, and allowed the formation of gels.

It was also demonstrated that the competition between the formation of hydrogen bonds between the solvents and bis-ureas on the one hand and the autoassociation of bis-ureas on the other hand may be counterbalanced by the preferential interaction between complementary spacers, here between xylene and trimethylbenzene spacers.

### Example 3: Effect of the Composition of EHUTMB/PIBUX Mixtures on the Formation of Gel in Dodecane

The conventional bis-urea EHUTMB is not soluble in non-polar solvents having long alkyl chains such as dodecane.

The functionalised bis-urea PIBUX is soluble in dodecane.

PIBUX/EHUTMB solutions at a concentration of 4 g/l in dodecane were prepared and a macroscopic observation of the resulting compositions was carried out.

Table 2 shows the results obtained for the various mixtures produced according to the molar quantity of functionalised bis-ureas (PIBUX) compared with the total molar quantity of bis-ureas introduced into the mixture.

TABLE 2
Macroscopic appearance of solutions comprising the bis-ureas PIBUX and
EHUTMB for various compositions
PIBUX/EHUTMB mixture
(% mol of PIBUX in the mixture)

| <30 | 30-70 | >70 |
|---|---|---|
| Precipitate | Gel | Liquid |

The results show that PIBUX improves the solubilisation of EHUTMB in dodecane; this is because, when the composition comprises mainly functionalised PIBUX bis-ureas (>70% mol PIBUX in the mixture), a homogeneous liquid solution is obtained: conventional and functionalised bis-ureas are solubilised in the medium.

Moreover, these results show that intermediate compositions of an EHUTMB/PIBUX mixture (that is to say where the quantity of EHUTMB and PIBUX is between 30% and 70% mol with respect to the total quantity of bis-ureas in the medium) make it possible to obtain elastic gels at ambient temperature without heating.

When the composition comprises mainly conventional EHUTMB bis-ureas (<30% mol PIBUX), the composition does not make it possible to obtain stable homogeneous gels.

In conclusion, these results show that stable gels are obtained for compositions comprising 30% to 70% mol functionalised PIBUX bis-ureas with respect to the total molar quantity of bis-ureas in the medium.

### Example 4. Revealing by Viscometry the Effect of Complementary Spacers for an EHUTMB/PIBUX Mixture in Toluene

This experiment aims to confirm, by viscometry, the effect of complementary spacers on the formation of gel in toluene.

In order to evaluate the influence of spacers on the viscosity of the mixture, the experiments were carried out in a solvent wherein conventional bis-ureas and functionalised bis-ureas are each individually soluble.

Several solutions of bis-ureas were produced in toluene, at a total concentration by mass of bis-ureas of 40 g/l and at a concentration by mass of between 13% and 16% bis-ureas with respect to the total quantity of solid:

solutions comprising conventional bis-ureas having a trimethylbenzene spacer (EHUTMB), alone;

solutions comprising a mixture of conventional bis-ureas having a trimethylbenzene (EHUTMB) spacer and functionalised bis-ureas having a trimethylbenzene (PIBUTMB) spacer;

solutions comprising a mixture of conventional bis-ureas having a trimethylbenzene spacer (EHUTMB) and functionalised bis-ureas having a xylene spacer (PIBUX).

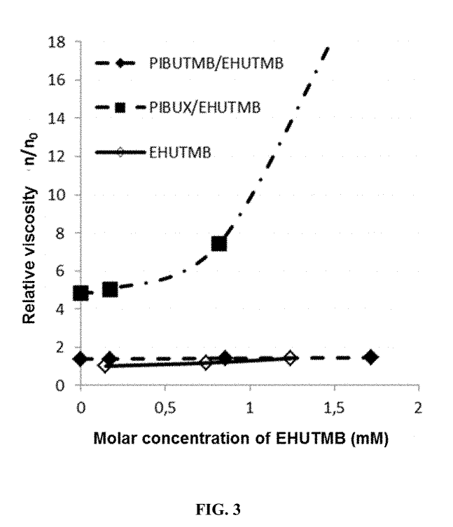

FIG. 3 presents the change in relative viscosities for these various solutions according to the molar concentration of conventional EHUTMB bis-ureas in the medium.

The results show that:

solutions comprising only conventional bis-ureas having a trimethylbenzene (EHUTMB) spacer are not very viscous, the solutions remain liquid;

the mixture of conventional EHUTMB bis-ureas and functionalised PIBTMB bis-ureas, having identical spacers (trimethylbenzene), leads to solutions having a viscosity comparable to that of solutions comprising conventional bis-ureas EHUTMB alone;

the mixture of conventional EHUTMB bis-ureas and functionalised PIBUX bis-ureas, having different and complementary spacers (respectively trimethylbenzene and xylene) leads to solutions having a viscosity greater than that of solutions comprising conventional EHUTMB bis-ureas alone.

In conclusion, these results confirm the importance of the pair of spacers selected in the mixing of conventional bis-ureas and functionalised bis-ureas, for formulating a gel. In particular, it was shown that the mixing of functionalised bis-ureas having a xylene spacer (PIBUX) with conventional bis-ureas having a trimethylbenzene spacer (EHUTMB) leads to increases in relative viscosity; representing a good autoassociation of these compounds in the mixture.

### Example 5: Revealing by FTIR Spectrometry the Effect of Complementary Spacers for EHUTMB/PIBUX Mixtures—Stability of the Gels Under Temperature

This experiment aims to evaluate, by FTIR spectroscopy, the stability under temperature of various compositions comprising the mixture of conventional bis-ureas having a trimethylbenzene spacer (EHUTMB) and functionalised bis-ureas having a xylene spacer (PIBUX).

FTIR analysis makes it possible to observe the absorption bands of the NHs of the urea functions. The NH bond resonates at a different frequency depending on whether it is bonded (<3400 cm⁻¹) or not (>3400 cm⁻¹) by hydrogen bonds to another urea function. Moreover, the ratio of the absorbances at 3330 and 3300 cm⁻¹ is characteristic of the structure of their assembly; this ratio is around 1.1 for the filamentary structure and around 1.3 for the tubular structure.

### 5.1. In Toluene

An analysis was carried out at various temperatures on an EHUTMB/PIBUX mixture in solution in toluene at a total concentration by mass of bis-ureas of 4 g/l, for EHUTMB/PIBUX compositions (% mol/% mol): 50/50 and 90/10.

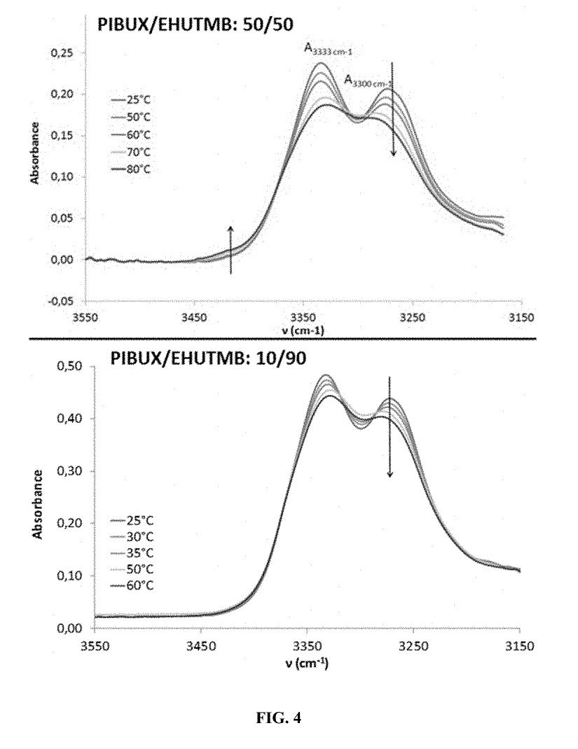

The results presented in FIG. 4 show that, for an EHUTMB/PIBUX mixture (50% mol/50% mol), the NH absorption bands change form when the temperature of the mixture is above or equal to about 70° C. The gel/liquid transition temperature of the EHUTMB/PIBUX mixture (50% mol/50% mol) in toluene is therefore about 70° C. The gel obtained by EHUTMB/PIBUX (50% mol/50% mol) in toluene therefore remains stable when it is heated at temperatures not exceeding 70° C.

For an EHUTMB/PIBUX mixture (90% mol/10% mol) the NH absorption bands change form when the temperature of the mixture is greater than or equal to about 50° C. The gel/liquid transition temperature of the EHUTMB/PIBUX mixture 90% mol/10% mol) in toluene is therefore about 50° C. The gel obtained by EHUTMB/PIBUX (90% mol/10% mol) in toluene therefore remains stable when it is heated to temperatures not exceeding 50° C.

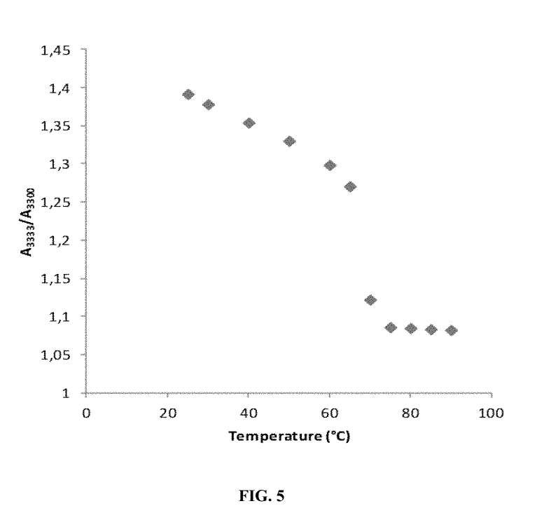

FIG. 5 presents the change in the ratio of the absorbances at 3330 and 3300 cm⁻¹ as a function of the temperature of an EHUTMB/PIBUX mixture (90% mol/10% mol). This representation confirms that the gel/liquid transition temperature for this mixture is about 50° C.

### 5.2. In Dodecane

An analysis was carried out at various temperatures on an EHUTMB/PIBUX mixture in solution in dodecane at a total concentration by mass of bis-ureas of 4 g/l, for EHUTMB/PIBUX compositions (% mol/% mol): 90/10; 30/70; 40/60; 60/40 and 70/30.

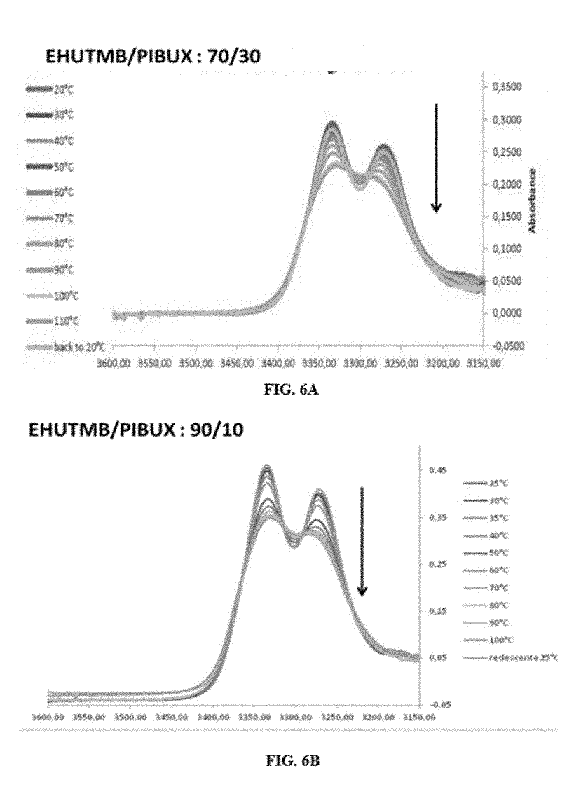

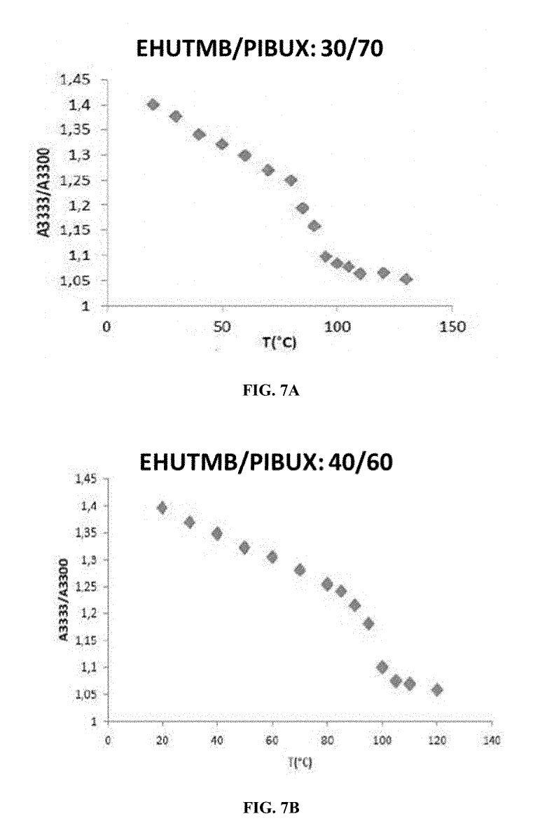

The results are presented in FIGS. 6 and 7.

Comparably with the experiments carried out in toluene, these results show that the NH absorption bands change form when the temperature of the mixture increases (examples for the EHUTMB/PIBUX (% mol/% mol) 90/10 and 70/30 compositions, FIGS. 6A and 6B).

FIGS. 7A-7E show that the gel/liquid transition in dodecane is above 50° C. In particular, the compositions comprising mixtures of 30% to 70% mol conventional bis-ureas and functionalised bis-ureas provide gels that are stable under temperature up to about 100° C.

### 5.3. Conclusions

In conclusion, these results show that it is possible, by FTIR spectroscopy 1) to evaluate the transition temperature from a gel state to a liquid state, and 2) to evaluate the stability under temperature of mixtures of bis-ureas. These results also show that mixing conventional bis-ureas and functionalised bis-ureas having complementary spacers according to the invention (here EHUTMB/PIBUX) makes it possible to obtain gels having improved stabilities under temperature (the mixtures remain stable at temperatures very much greater than ambient temperature).

### Example 6: Influence of Temperature on the Relative Viscosity of EHUTMB/PIBUX Mixtures

The mixing of conventional bis-ureas having a trimethylbenzene spacer (EHUTMB) and functionalised bis-ureas having a xylene spacer (PIBUX) was studied in toluene, a solvent wherein these two bis-ureas are soluble, at a total concentration of bis-ureas in toluene of 2 g/l.

The aim is to evaluate the temperature range over which the EHUTMB/PIBUX provides a stable gel. For this purpose, the relative viscosity of various EHUTMB/PIBUX compositions was measured at 20° C., 40° C., 60° C. and 80° C.

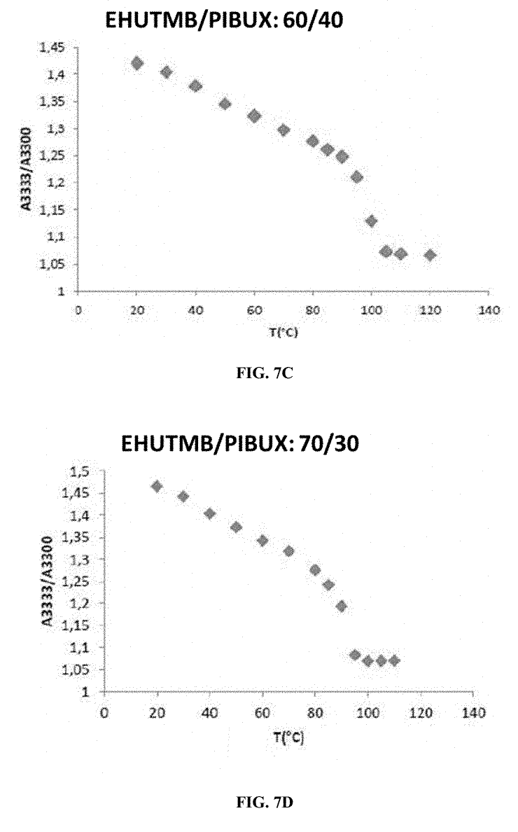

The results (FIG. 8) show that the EHUTMB/PIBUX composition (50% mol/50% mol) has a very high relative viscosity (>18) when this mixture is heated to a temperature below 80° C.; on the other hand, the viscosity is minimal when the mixture is heated to 80° C.

In addition, these results show that:

a solution comprising only EHUTMB is of very low viscosity whatever the temperature (20°, 40°, 60° or 80° C.);

a solution comprising only PIBUX is moderately viscous at 20° C. and becomes less and less viscous when the temperature is increased up to 80° C.;

a solution comprising a PIBUX/EHUTMB mixture has high viscosities at temperatures ranging up to 60° C., in particular an equimolar PIBUX/EHUTMB mixture is stable up to a temperature of 67° C.

Consequently these results show that an equimolar mixture of conventional bis-ureas having a trimethylbenzene spacer and functionalised bis-ureas having a xylene spacer makes it possible to obtain a gel that is stable up to a temperature of 67° C.

### Example 7: Rheological Analysis of EHUTMB/PIBUX Mixtures in Dodecane

A mixture of conventional EHUTMB bis-ureas and functionalised PIBUX bis-ureas at an EHUTMB/PIBUX molar composition of 90/10 was studied in rheology.

The EHUTMB/PIBUX mixture (90/10) is in solution in dodecane at a total concentration by mass of bis-ureas of 4 g/l.

Rheological analysis, and in particular a study of the modulus of elasticity G′ and of the viscosity modulus G″ of a sample, makes it possible to evaluate the rheological behaviour of a material. This is because a material is considered to be an elastic gel if G′>G″.

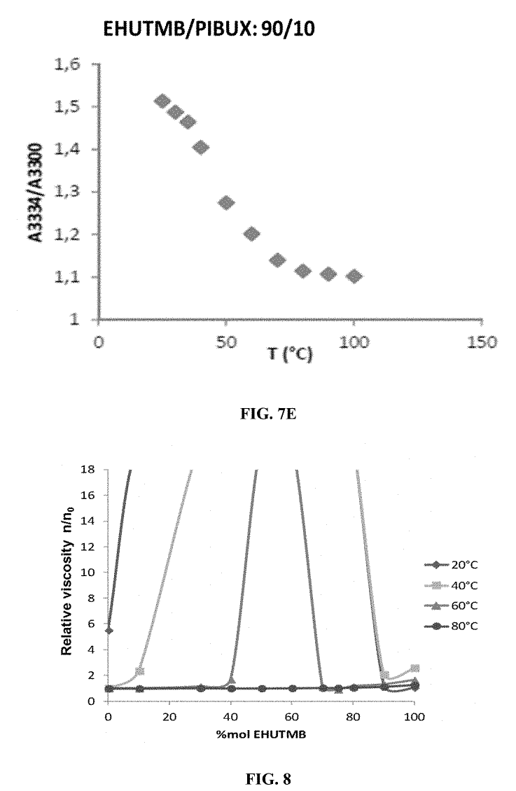

FIG. 9 presents the modulus of elasticity G′ and the viscosity modulus G″ of the EHUTMB/PIBUX mixture (90/10 as a function of the scanning frequency for a force of 3 Pa, at a temperature of 25° C.

FIG. 9 also presents the same analysis carried out after 7 months.

These results show:

firstly that G′>G″, that is to say that the gel is elastic,

secondly, after 7 months, the sample has moduli G′ and G″ comparable to those obtained at t=0.

In conclusion, the EHUTMB/PIBUX mixture in dodecane, at a 90/10 molar composition, has an elastic gel behaviour that is stable over time.

### Example 8: Obtaining Gels in Oils

### 8.1. From an EHUTMB/PDMSUT Mixture in a Silicone Oil

The mixture of conventional bis-ureas having a trimethylbenzene spacer (EHUTMB) and functionalised bis-ureas of formula (III) having a toluene spacer (PDMSUT) was studied in a silicone oil, decamethylcyclopentasiloxane (D5), at a concentration of 25 g/l.

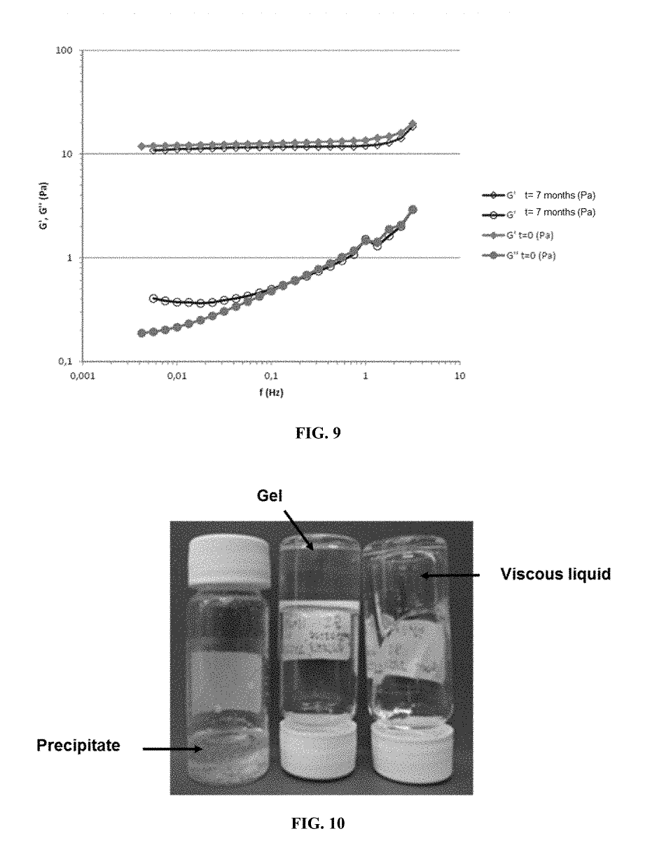

The results (FIG. 10) show that:

a solution comprising only EHUTMB is insoluble in silicone oil;

a solution comprising only PDMSUT is viscous but does not form a gel;

a PDMSUT/EHUTMB mixture [molar ratio 1:2] makes it possible initially to solubilise each EHUTMB and PDMSUT bis-urea in silicone oil and secondly makes it possible to obtain a stable gel.

Consequently these results show that a mixture of conventional bis-ureas having a trimethylbenzene spacer and functionalised bis-ureas having a toluene spacer makes it possible to obtain a stable gel in solvents wherein conventional bis-ureas are not soluble, such as silicone oil.

### 8.2. From an EHUTMB/PIBUX Mixture in PA06 Mineral Oil

The mixture of conventional bis-ureas having a trimethylbenzene spacer (EHUTMB) and functionalised bis-ureas of formula (II) having a xylene spacer (PIBUX) was studied in PA06 mineral oil at a concentration of 10 g/l.

The results show that:

a solution comprising only EHUTMB is insoluble in PA06 (formation of a white precipitate);

a solution comprising only PIBUX is viscous but does not form a gel;

an equimolar PIBUX/EHUTMB mixture makes it possible initially to solubilise each EHUTMB and PIBUX bis-urea in PA06 and secondly makes it possible to obtain a gel.

Consequently these results show that a mixture of conventional bis-ureas having a trimethylbenzene spacer and functionalised bis-ureas having a xylene spacer makes it possible to obtain a stable gel in solvents wherein conventional bis-ureas are not soluble, such as PA06.

### Example 9: Obtaining Gels from an EHUTMB/POEUX Mixture in Acetonitrile

The mixture of conventional bis-ureas having a trimethylbenzene spacer (EHUTMB) and bis-ureas functionalised by polyethylene oxide chains of formula (II) having a xylene spacer (POEUX) was studied in acetonitrile at a concentration of 25 g/l.

The results show that:

a solution comprising only EHUTMB is insoluble in acetonitrile (formation of a white precipitate);

a solution comprising only POEUX is viscous but does not form a gel;

an equimolar POEUX/EHUTMB mixture makes it possible initially to solubilise each EHUTMB and POEUX bis-urea in acetonitrile and secondly makes it possible to obtain a gel.

Consequently these results show that a mixture of conventional bis-ureas having a trimethylbenzene spacer and functionalised bis-ureas having a xylene spacer makes it possible to obtain a stable gel in solvents wherein conventional bis-ureas are not soluble, such as acetonitrile.

### Materials and Methods

### Materials

The conventional bis-ureas and the functionalised bis-ureas employed in the present invention have previously been synthesised according to the protocols described in the literature: EHUT (Lortie, F. et al., Langmuir 2002, 18, 7218); EHUTMB (Isare, B. et al., J. Phys. Chem. B 2009, 113, 3360); EHUX (Isare, B. et al Langmuir 2012, 28(19), 7535); PIBUT (Pensec, S. et al., Macromolecules 2010, 43 (5), 2629); PIBUX (Thesis by Cécile Fonteneau, “Synthesis and properties of supramolecular polymers associated by hydrogen bonds by means of urea units, Université Pierre et Marie Curie: Paris, France, 2013); PABUX (Fonteneau, C. et al., Polym. Chem. 2014, 5(7), 2496); POEUX (Obert, E. et al., J. Am. Chem. Soc. 2007, 129(50), 15601) and PDMSUT (Colombani et al., Macromolecules 2005, 38, 1752).

The synthesis of PIBUTMB (polyisobutyleneureidotrimethylbenzene) was carried out in accordance with the following protocol:

1 eq. of 2,4,6-trimethyl-1,3-phenylenediisocyanate was dissolved in anhydrous dichloromethane under inert atmosphere, and the mixture was transferred via a cannula into a stirred solution of Kerocom® polyisobutylene amine (Kerocom® PIBA, 60% in solution in hydrocarbon, BASF, about 2 eq.) at ambient temperature under inert atmosphere. The reaction was left at rest for one night under agitation at ambient temperature, under inert atmosphere. A colourless viscous liquid was obtained and then the liquid was precipitated drop by drop on two occasions into ethyl acetate under agitation. A clear colourless oil was obtained after settling, and extracted with ethyl acetate. This oil was dried under vacuum (1.10⁻³ mbar) at 60° C. A colourless viscous oil was obtained (75%). The product obtained was characterised by steric exclusion chromatography in THF, at a concentration of 5 mg.ml⁻¹ (results given in polystyrene equivalent) and by ¹H NMR.

| | PIBUTMB |
|---|---|
| Mₙ (g · mol⁻¹) | 2804 |
| M_{w} (g · mol⁻¹) | 3561 |
| M_{w}/Mₙ | 1.27 |

¹H NMR (500 MHz, CDCl₃-DMSO-d₆, 50° C.) δ (ppm): 0.89-1.36 (m, 297 H, CH₃—(CH₂—C(CH₃)₂)ₙCH₂—CH(CH₃)—CH₂; 2.04-2.09 (m, 9H, CH₃-Ph); 3.08 (m, 4H, CH₂—NH); 5.25 (s, 2H, CH₂—NH); 6.68 (s, 2H, Ph-NH); 6.80 (s, 1H, Ph-H). DP=32.82; Mₙ=2330 g.mol⁻¹

### Viscometry

The solutions for viscometric analysis were prepared in anhydrous toluene, previously filtered with 0.45 μm porosity filters. Solutions of functionalised bis-ureas were prepared at 80 g/l and conventional bis-urea solutions were prepared at concentrations of 5 mM. The solutions were agitated on a vibrating plate for 10 days. The solutions of EHUX were then heated to 80° C. under constant agitation for 12 hours in order to obtain a complete dissolution of the bis-ureas in solution. The solutions comprising conventional bis-ureas were mixed with functionalised bis-ureas by means of polymer chains and supplemented with a filtered solvent in order to obtain compositions comprising 1% mol, 5% mol and 10% mol conventional bis-ureas in the mixture, for a total solid concentration amounting to 40 g/l. The mixtures obtained were agitated for one night in order to homogenise the compositions before viscometric analysis at 20° C., 40° C., 60° C. and 80° C. The solvents used were also analysed in order to determine the relative viscosity of the samples. The apparatus used for these analyses was an Anton Paar AMVN falling-ball microviscometer.

### Fourier Transform InfraRed Spectroscopy (FTIR)

The solutions were prepared by separately dissolving the conventional and functionalised bis-ureas by polymers in toluene (2 g/l). These solutions were next stirred on a vibrating plate for 10 days. Then these two solutions were mixed in accordance with the following conventional bis-urea/functionalised bis-urea compositions (% mol/% mol): 10/90; 20/80; 30/70; 40/60; 50/50; 60/40; 70/30; 80/20 and 90/10. The mixtures obtained were then stirred for one night in order to homogenise the compositions before FTIS analysis.

For the purpose of obtaining thermal equilibrium during analyses for each temperature studied, the measurements were made after 30 minutes of equilibration at the target temperature. The spectra of the solvent alone were conducted at each temperature under the same conditions as those used for the bis-urea solutions and then these measurements were subtracted from those of the samples.

The spectra were recorded by means of a Nicolet Is10 spectrometer equipped with a VTC21525 heating apparatus supplied by SPECAC, in 2 mm optical path vessels, equipped with CaF₂ windows.

### Rheology

The rheological analysis was carried out on a HAAKE Rheostress (RS) 600 rheometer, with a geometry of the flat cone type, 4 cm diameter, angle 2°, C35 2° Ti L04026 titanium.

The sample was placed on the surface of the rheometer. Then the geometry of the equipment was adjusted. The sample was heated to 80° C. for 15 minutes and then left at rest for 25° C. for 2 hours before force and frequency scanning.

Measurement of the Number Average Molar Mass Mₙ and Mass Average M_{w}

The number average molar mass Mₙ and mass average M_{w} of the macromolecular chains were determined by steric exclusion chromatography (SEC) in THF at a rate of 1 ml/minute. The apparatus used is the Viscotek Detector Array Model TDA 30 2 equipped with a light-diffusion detector (LALS: θ=7°, RALS: θ=90°; laser: λ=670 nm), a refractive index detector (λ=670 nm), a viscometric detector and three Polymer Laboratoires Miced C columns, thermostatically controlled at 40° C.

1-10. (canceled)

11. Composition comprising a mixture of conventional bis-ureas and bis-ureas functionalised by macromolecular chains, wherein:
the conventional bis-ureas are of general formula (I) 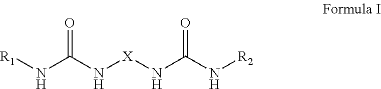
wherein
X represents a phenyl group substituted by at least one alkyl chain comprising 1 to 4 carbon atoms and/or at least one halogen selected from Cl or Br;
R₁ and R₂ each represent independently a linear or branched group, selected from alkyl, alkene, alkyne, aryl, arylalkyl, heteroaryl, heteroalkyl, heteroalkene or heteroalkyne; said linear or branched group optionally being substituted by a halogen, alkyl, alkene, alkyne, heteroalkyl, heteroalkene or heteroalkyne group;
the bis-ureas functionalised by macromolecular chains are of general formula (II) 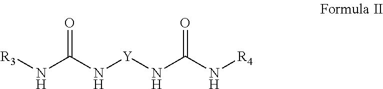
wherein
Y represents a phenyl group substituted by at least one alkyl chain comprising 1 to 4 carbon atoms and/or at least one halogen selected from Cl or Br;
at least one of R₃ and R₄ represents a macromolecular chain, and
one of X and Y is optionally substituted by one or two groups each independently selected from an alkyl chain comprising 1 to 4 carbon atoms and/or a halogen selected from Cl or Br; and the other of X and Y is substituted by three or four groups, each independently selected from alkyl chains comprising 1 to 4 carbon atoms and the halogens selected from Cl or Br.

12. Composition according to claim 1, wherein at least one of R₃ and R₄ represents a macromolecular chain selected from the family comprising polyacrylates, polymethacrylates, polyolefins, polycarbonates, polyethers, polydienes, polyvinyl acetates, polycarbonates, polysiloxanes, polyesters, polynorbornenes, polycyclooctenes and polystyrenes; and the other one of R₃ and R₄ represents a linear or branched group, selected from alkyl, alkene, alkyne, aryl, arylalkyl, heteroaryl, heteroalkyl, heteroalkene or heteroalkyne; said linear or branched group optionally being substituted by a halogen, alkyl, alkene, alkyne, heteroalkyl, heteroalkene or heteroalkyne group, or a macromolecular chain.

13. Composition according to claim 1, wherein R₃ and R₄ are identical and each represent a macromolecular chain of polyisobutene or poly(butyl acrylate).

14. Composition according to claim 1, wherein the conventional bis-ureas of formula (I) are selected from ethylhexylureidotoluene (EHUT), ethylhexylureidotrimethylbenzene (EHUTMB) and ethylhexylureidoxylene (EHUX).

15. Composition according to claim 1, wherein the bis-ureas of formula (I) are EHUTMB molecules.

16. Composition according to claim 1, wherein the bis-ureas functionalised by macromolecular chains of formula (II) are selected from poly(isobutene)ureidotoluene (PIBUT), poly(isobutene)ureidotrimethylbenzene (PIBUTMB), poly(isobutene)ureidoxylene (PIBUX) and poly(butyl acrylate)ureidoxylene (PABUX).

17. Composition according to claim 1, wherein the functionalised bis-urea is selected from PIBUX and PABUX.

18. Composition comprising the mixture according to claim 1, and at least one solvent.

19. Composition comprising the mixture according to claim 1 and a solvent, wherein the solvent is selected from non-polar solvents having long alkyl chains or polar solvents.

20. Method for preparing a composition comprising the mixture according to claim 1 and at least one solvent, wherein the method comprises mixing conventional bis-ureas of formula (I) and functional bis-ureas of formula (II) with at least one solvent, under gentle stirring and optionally in the presence of heating.

21. Method according to claim 10, wherein the solvent is a non-polar solvent having long alkyl chains or an oil.

22. Method according to claim 10, wherein said oil comprises vegetable, animal, mineral or synthetic oils, liquid hydrocarbon combustibles, fuels, lubricants.

23. Method according to claim 10, wherein said oil is PA06 oil.

24. Method according to claim 10, wherein the solvent is a polar solvent.

25. Additive comprising the mixture according to claim 1, wherein said additive is present in a cosmetic composition, or an ink, in a fuel, or in a lubricant.

26. Organogelator comprising a composition comprising the mixture according to claim 1 and at least one solvent.

27. Organogelator comprising a composition comprising the mixture according to claim 1 and at least one solvent, wherein said organogelator is present in a cosmetic preparation, an ink, a fuel or a lubricant.
